(19) United States
(12) Patent Application Publication
(10) Pub. No.: US 2022/0188946 A1
(43) Pub. Date: Jun. 16, 2022

(54) CUSTOMER-CENTRIC METHOD AND SYSTEM FOR PRICING OPTIONS AND PRICING/CHARGING CO-OPTIMIZATION AT MULTIPLE PLUG-IN ELECTRIC VEHICLE CHARGING STATIONS

(71) Applicants: TOTALENERGIES SE, Courbevoie (FR); The Regents of the University of California, Oakland, CA (US)

(72) Inventors: Scott MOURA, Berkeley, CA (US); Teng ZENG, Berkeley, CA (US); Sangjae BAE, Berkeley, CA (US); Wente ZENG, San Francisco, CA (US); Carl LENOX, San Rafael, CA (US); Bertrand TRAVACCA, Oakland, CA (US)

(73) Assignees: TOTALENERGIES SE, Courbevoie (FR); The Regents of the University of California, Oakland, CA (US)

(21) Appl. No.: 17/541,510

(22) Filed: Dec. 3, 2021

Related U.S. Application Data
(60) Provisional application No. 63/121,734, filed on Dec. 4, 2020.

(51) Int. Cl. G06Q 50/06; G06Q 30/02

(52) U.S. Cl. CPC G06Q 50/06; G06Q 30/0283

(57) ABSTRACT

A station-level framework to operate one or multiple plug-in electric vehicle (PEV) charging stations with optimal pricing policy and charge scheduling, which incorporates human behavior to capture the driver charging decision process. The user is presented with menu of price-differentiated charging services, which differ in per-unit price and the energy delivery schedule. Involving human in the loop dynamics, the operation model results in the alleviation of the overstay issue may occur when a charging session has completed. A multi-block convex transformation is used to reformulate the resulting non-convex problem via the Fenchel-Young Inequality and a Block Coordinate Descent algorithm is applied to solve the overall problem with an efficiency which enables real-time implementation. The pricing control policy realizes benefits in three aspects: (i) net profits gain, (ii) overstay reduction, and (iii) increased quality-of-service.

### CROSS-REFERENCE TO RELATED APPLICATIONS

The present application claims the benefit of U.S. Provisional Application No. 63/121,734, entitled “A Customer Centric Design For Pricing Options And Pricing/Charging Co-Optimization At Multiple Plug-In Electric Vehicle Charging Stations”, filed on Dec. 4, 2020, and incorporated herein by reference in its entirety.

### STATEMENT REGARDING PRIOR DISCLOSURE BY THE INVENTORS

Aspects of this technology are described in an article “Inducing Human Behavior to Maximize Operation Performance at PEV Charging Station” presented at the 2020 American Control Conference in new journal of chemistry, arXiv:1912.0234v1[eess.SY] on Dec. 5, 2019, which is incorporated herein by reference in its entirety.

### FIELD

Methods and systems for managing one or multiple plug-in electric vehicle (PEV) charging stations, taking into account a human decision process, overstay at the charging station, and the overall operational performance.

### BACKGROUND

Forecasts project that PEV sales will account for one third of the entire vehicle sales market by 2025, and that more than one half of the new vehicles sold will be electric vehicles by 2030. However, inadequate charging access may heavily impede this growth in the PEV market. The competition for charging resources is greater in dense population areas, e.g., workplace and metropolitan areas. A PEV could occupy one charger, even if it is not charging or after the charging session has been completed, for a long duration until the driver returns from work, shopping, dining, etc. At this time, such an overstay typically occupies charger access 6-8 hours per day, which prevents other PEVs from accessing the charging services at the particular location. To address the overstay issue, station operators may (i) hire a human valet to rotate vehicles, (ii) apply a steep parking charge, and/or (iii) install more chargers to satisfy demand. The first and third options impose costs on the station operator and the second transfers the costs to customers, which may impair the quality of service.

The overstay issue can be understood by referring to a statistical analysis from real world data. A PEV charging station, equipped with 12 level-2 (240V, 30A) chargers, is located in San Luis Obispo, Calif. Dating back to 2017, this station has been extensively utilized with 679 charging sessions on average and 94 unique user identities per month. In this dataset, the average plug-in duration has been 3.5 hours, but the actual charging duration has been only around 2 hours. The analysis shows that in more than 90% of the sessions, the PEV tends to remain plugged-in and overstay for an extra 1.5 hours. As a result, the longer the PEVs are plugged-in, the more severe were the overstay effects. Some station operators have addressed this issue by applying an idle fee to overstaying vehicles, therefore encouraging drivers to move their vehicle once finished charging. The overstay issue has become a universal problem that many station operators face.

Accordingly, it is an object of the present disclosure to describe a method of optimizing charging station operation and charging station pricing structure for a plurality of charging terminals that incorporates overstay and human behavior and minimizes charging station costs.

### SUMMARY

Embodiments of the present disclosure describe methods and systems for charging station optimization.

The embodiments describe a station-level framework to operate one or multiple plug-in electric vehicle (PEV) charging stations with optimal pricing policy and charge scheduling, which incorporates human behavior to capture the driver charging decision process.

In an embodiment, a driver of a PEV is presented with a menu of price-differentiated charging services, which differ in per-unit price and the energy delivery schedule.

In another embodiment, an operation model applies human-in-the-loop dynamics to the decision-making process and the operational model, which results in alieving the overstay issue may occur when a charging session has completed.

In a further embodiment, a multi-block convex transformation is used to reformulate the resulting non-convex problem via a Fenchel-Young Inequality, then a Block Coordinate Descent algorithm is applied to solve the overall problem with an efficiency which enables real-time implementation. The pricing control policy realizes benefits in three aspects: (i) net profit gain, (ii) overstay reduction, and (iii) increased quality-of-service.

The foregoing general description of the illustrative embodiments and the following detailed description thereof are merely exemplary aspects of the teachings of this disclosure, and are not restrictive.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1A is an overview of an exemplary charging system for addressing the overstay problem, maximizing throughput, and optimizing costs at a charging station, according to a described embodiment.

FIG. 1B is an overview of is an overview of user communication with the charging system, according to a described embodiment.

FIG. 1C illustrates a charging system controller which links to a plurality of charging stations, according to a described embodiment.

FIG. 2 is a diagram illustrating a PEV charging station work-flow illustrating the charging station process and proactive interaction with new users, according to a described embodiment.

FIG. 3 is a graph showing the probability of overstay based on overstay duration, according to a described embodiment.

FIG. 4A is a graph illustrating a power profile of one-day operation of a charging station controller, according to a described embodiment.

FIG. 4B is a graph illustrating a profit profile of one-day operation of a charging station controller, according to a described embodiment.

FIG. 4C is a graph illustrating a profile of the number of vehicles at each hour of the day for a one-day operation of a charging station controller, according to a described embodiment.

FIG. 4D is a graph illustrating an overstay profile of one-day operation of a charging station controller, according to a described embodiment.

FIG. 4E is a graph illustrating a profile of the number of services for a one-day operation of a charging station controller, according to a described embodiment.

FIG. 5 is a graph illustrating the optimal pricing policies over time and hourly time-of-use price, according to a described embodiment.

FIG. 6A illustrates the probability distribution of choice options over charging events, where each area represents the probability of choosing each option, according to a described embodiment.

FIG. 6B illustrates a representation of the frequency at which vehicles selected one of the three pricing options of FIG. 6A, according to a described embodiment.

FIG. 7 illustrates overstay associated with requested energy and stated parking duration, according to a described embodiment.

FIGS. 8A-8C are graphs illustrating Monte Carlo simulation results for mean overstay duration, net profit, and number of services provided, respectively, according to a described embodiment.

FIG. 9 is a graph illustrating the station-wide power optimization compared to single-charger optimization, according to a described embodiment.

FIG. 10A illustrates a sensitivity analysis of varying the number of charging terminals for profit with incentive control (left) and without incentive control (right), according to a described embodiment.

FIG. 10B illustrates the quality of service for controlled and uncontrolled charging, according to a described embodiment.

FIG. 11A illustrates the total session duration in hours for a dataset of 703 charging sessions for 12 level 2 charging terminals (240V, 30A), according to a described embodiment.

FIG. 11B illustrates the charging duration in hours for the dataset of FIG. 11A, according to a described embodiment.

FIG. 12 illustrates a framework for charging system control of a plurality of PEV charging terminals, according to a described embodiment.

FIG. 13 illustrates a charging interface as shown on a user device, according to a described embodiment.

FIG. 14 is a histogram showing the number of charging terminals in different cities in the U.S. in 2017 compared to the estimated number of charge points needed by 2025.

### DETAILED DESCRIPTION

Referring now to the drawings, like reference numerals designate identical or corresponding parts throughout the several views.

Aspects of the present disclosure describe a customer-centric approach to charging. Upon accessing a native application or a website, charging session options are presented to each customer. Pricing and/or carbon intensity of each option is updated in real time based on the time-varying cost of energy for both the site host and the electricity provider, maximum power constraints and/or demand charges, greenhouse gas emissions associated with electricity production, and charge point demand, with the objective of maximizing financial value for the charge point operator while meeting customer expectations for quality of service. Customers may choose a “regular” charging session, in which the vehicle starts charging immediately and continues at full power until the vehicle is charged or the customer ends the charging session, or a “scheduled” option with a reserved session duration and guaranteed energy delivery.

The prices of each option are dynamically determined when the customer starts the process of requesting a charging session, and are based on the relative cost and value to the charge point operator including any power constraints, the expected price elasticity of demand for the customer, and the current and forecasted level of demand for charging services/charge point occupancy. Prices may be calculated and/or expressed as price per unit time (for the “regular” option and for “overstay” of the scheduled duration), price per unit energy, as a fixed session cost (for the “scheduled” option), or as combination of these cost elements. In scheduled charging, an artificial intelligence (AI)-based dispatch optimization algorithm updates the power delivered to each charger in real time to fulfill the energy requirement by each customer by prioritizing the grid power during low-cost and low-CO₂ emission periods (green power generated by renewables), while respecting power constraints and the customer's schedule. In the scheduled case, an “overstay” price element is used to encourage drivers to move their vehicles once finished charging, to improve charge point utilization. As used in the present disclosure, overstay is defined as the duration of time after PEV charging is completed or a charging session is completed when the PEV continues to occupy a charger.

Direct applications for a customer-centric approach to charging include PEV charging station management, where charging prices and overstay price are subject to optimization. In general, this approach may also be applied in Distributed Energy Resource (DER) applications, in which customers have a discrete set of choices between service options and their prices and services are subject to optimization. In an aspect of the present disclosure, an operational process at a PEV charging station with different charging service options is described, which allows PEV drivers to refuse a charging service. Discrete Choice Modeling (DCM) is used to capture the decision-making process of PEV drivers.

For verification of the human behavioral model of the present disclosure, a survey preference study was conducted and response data was compared to results from the behavioral model. The behavioral model effectively captured human decision-making upon exposure to multiple charging mode options, which differ in both price and energy delivery schedule.

In an aspect of the present disclosure, a station level optimization model that considers customer charging demands and station operating costs is described. The model framework leverages the DCM to capture the probabilities of a user choosing different charging service options, and incorporates the overstay factor, both of which are responsive to the pricing policy. The DCM incorporates the customer charging demands, human behavior and station operating costs into the optimization and outputs a set of probabilities of the customer choosing specific combinations. The choice of any particular probability is a non-convex optimization problem.

In order to solve the non-convex optimization problem, it is reformulated into a three-block multi-convex problem via a Fenchel-Young transformation. The three-block multi-convex problem is solved by a Block Coordinate Descent (BCD) algorithm which enables real-time implementation.

The multi-objective optimization framework is designed to maximize the net profit of the charging station operator, and may also optimize for other non-economic objectives, such as minimizing greenhouse gas emissions for environmental benefits and maximizing charging station utilization (reducing overstay) for societal benefits.

Research on the operation of PEV charging stations can be generally organized into at least three different categories based on the system boundaries under consideration. From a broad to narrow perspective, these three categories involve (i) network level interactions with other systems, (ii) single station interactions with renewable energies, and (iii) single station operations without interacting with any outside resources. In category (i), the two interacting systems are the power system and transportation system, and charging stations serve as an intermediary agent that couple the transportation and electric grid networks and enable aggregated PEVs to participate in electricity and ancillary service markets. There are also extensive studies on the joint operation of coupled transportation power networks, whose objective is to simultaneously reduce congestion in both networks. For (ii), the operational concerns involve power management of PEV charging, solar photovoltaic generation, and/or storage systems to enhance performance. In category (iii), the methodologies focus solely on single station operation: charging management, customer satisfaction, quality of service, etc. However, conventional solutions do not consider customer decision-making.

The charging system to customer interaction approach is distinguished by proactive reaction vs. reactive interaction. In a reactive setting, the station operator manages charging by taking into account charging costs and a “user convenience factor”. The underlying assumption is that users would prefer their PEVs to complete charging as soon as possible. While this approach does enhance operation performance in minimizing user wait times, it fails to manage the charging session optimally and fails to acknowledge the overstay problem. In a proactive setting, the charging station system interacts with PEV drivers to influence charging decisions. Conventional solutions have included adding admission control upon arrival of a vehicle, introducing differentiated services and designing optimal pricing schemes and routing schemes with the focus of price-incentivizing PEV drivers to charge at designated sites to maximize social welfare. However, as a detailed charging operation is missing from this model, the overstay issue has previously been ignored and the service providers have tried to nudge potential customers to different stations. In comparison, an aspect of the present disclosure incentivizes customers to use different charging mode options at the station. As a result, the present disclosure closes the research gap in operating single charging stations by proactively interacting with customers.

Additionally, overstay reduces station utilization. A previous study introduced an “interchange” operation, which proactively unplugged fully charged PEVs. The study proposed a new station planning model and evaluated the financial burdens both to the station operator and the users. (See Zeng, T., Moura, S., Shang, H., “Solving overstay and stochasticity in PEV charging station planning with real data”, IEEE Transactions on Industrial Informatics, Volume: 16, Issue: 5 May 2020, incorporated herein by reference in its entirety). To manage deferrable loads, a “deadline differentiated pricing” scheme was used to incentivize customers with a lower electricity price to defer their latest departure times, providing the station operator more charge schedule flexibility. However, this incentive system naturally increased the overstay, since the users were encouraged to occupy chargers for longer times. In the present disclosure, the overstay problem is addressed without a prior assumption that deferring departure results in lower customer charging cost.

In an aspect of the present disclosure, the “human-in-the-loop” dynamics that occur between the charging service provider and the customers (PEV drivers) are addressed. When facing the need to charge, the customers must consider parking spot availability, charger speed, prices for electricity and parking, overstay price, etc. The customers then decide whether to receive the charging service, and if so, which service to choose from a menu of pricing options. When a customer's decision-making process is understood at the individual level, the station operators may strategically target charging prices to maximize profits as well as enhance overall station throughput. Human inputs may be influenced via designed incentives. In the present disclosure, these “human actuated systems” are adapted to incentivize customers towards desired charging options.

A preliminary version of incorporating overstay in a charging terminal optimization model at a single charger level was presented by the inventors. (See: Bae, S., Xeng, T, Travacca, B, Moura, S., “Inducing Human Behavior to Maximize Operation Performance at PEV Charging Station”, published in eprint arXiv: 1912.02341v1, on Dec. 5, 2019, which is incorporated herein by reference in its entirety). This model incorporates pricing and charge scheduling simultaneously by explicitly incorporating a model of human decision-making for a single charging terminal. However, global optimality at the station level was not considered. As a result, local circuit and transformer capacity and demand charge cost, which composes a significant portion of the station operating cost, could not be considered. In the present disclosure, the aggregate load at the station level is used to generate optimal prices to maximize station operator net profit.

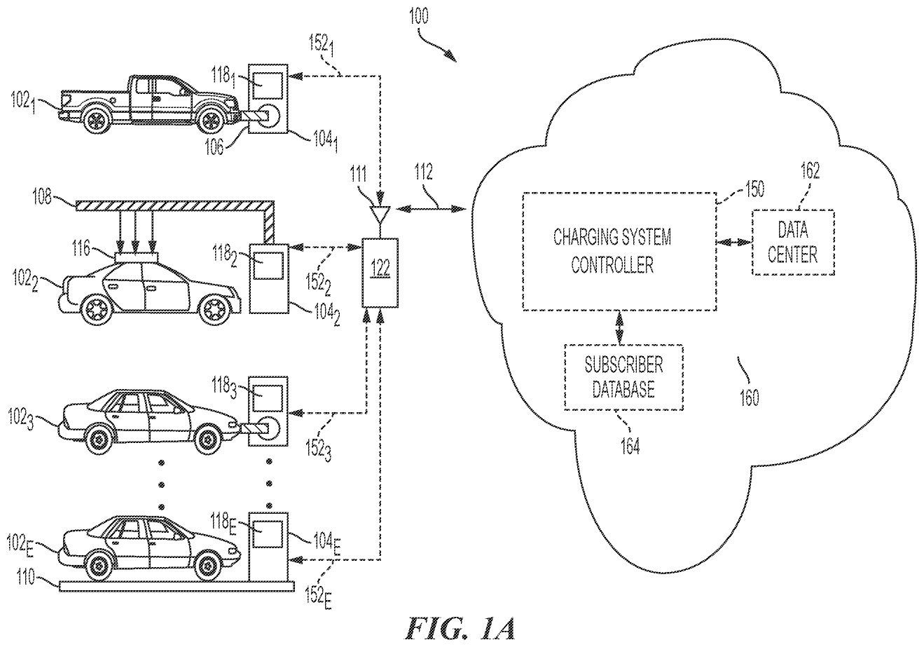

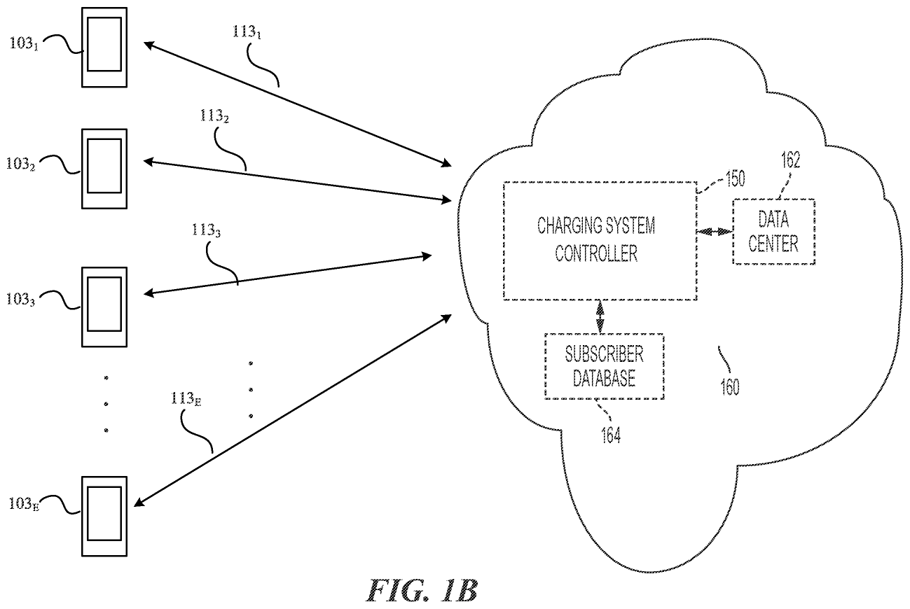

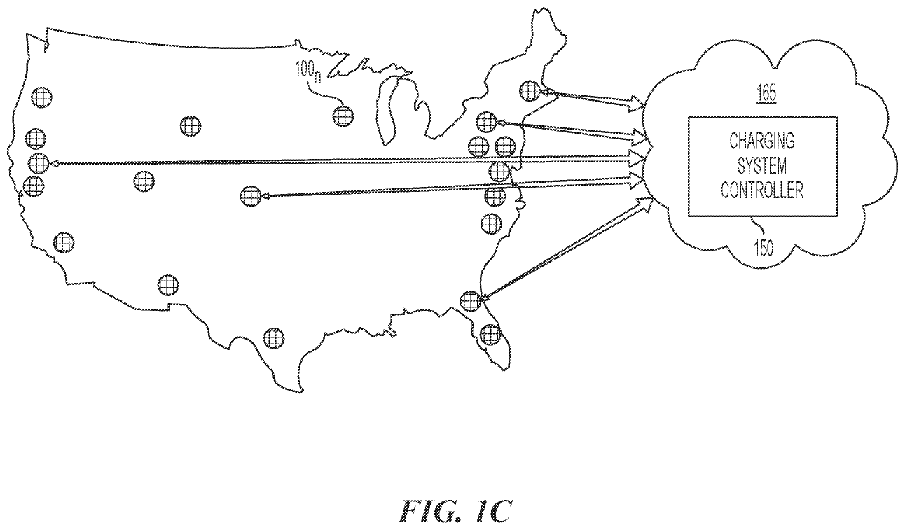

FIG. 1A shows an overview of an exemplary PEV charging station 100. Charging terminals 104i (i=1 . . . E), where E equals the number of charging terminals at the PEV charging station, are shown with vehicles 102ᵢ(i=1 . . . E) docked into charging terminals 104i. Each charging terminal 104ᵢ may be equipped for charging by connecting a charging cable of the vehicle to a plug 106, as shown for vehicles 102₁ and 102₃ plugged into charging terminals 104₁ and 104₃ respectively. Alternatively, a charging terminal 104₂ may be equipped to provide contactless charging, as shown for vehicle 102₂, in which wireless electromagnetic radiation, e.g., from overhead power lines 108, directly charges an inductive charger 116 on or in the roof of the vehicle 102₂. Power lines 108 may alternatively be located under or flext to the vehicle 102₂. In another alternative, a charging terminal 104_{E} may be equipped to provide inductive charging 110, as shown for vehicle 102_{E}, in which electromagnetic radiation is used to wirelessly charge a coil (not shown) in, e.g., the undercarriage of the vehicle. Inductive charging 110 may alternatively be located above or flext to the vehicle 102_{E}. However, the charging terminal is not limited to a specific type of plug-in or inductive coupling to an electric vehicle, and may be any kind of physical/wireless connection that charges an electric vehicle battery. As used in the present disclosure, the term “plug-in electric vehicle” or “PEV” means any type of electric vehicle that can receive power from a charging terminal.

As shown in FIG. 1A, each charging terminal 104ᵢ may have a display screen 118ᵢ, which can show information, such as charging time, ON, OFF, or the like, to a driver of a vehicle. The driver may interact with the charging system controller 150 through a downloadable native application or by accessing a website through his/her user device, e.g., a smartphone, tablet, personal computer connected to a hotspot, or the like.

Each charging terminal 104ᵢ is connected (e.g., shown as communication lines 152₁, 152₂, 153₃, . . . ,152_{E}) through an access point 122 to a cloud computing infrastructure 160 which includes resources for a charging system controller 150. The access point 122 may have an antenna 111 which bi-directionally communicates with cloud computing infrastructure over communication channel 112. The antenna 111 may be a plurality of antennas, each configured for a different type of communication, such as WIFI®, BLUETOOTH®, RF, LTE®, 3G, 4G®, 5G™, or the like. For example, the antenna 111 may communicate by near field communications, such as BLUETOOTH® or WIFI®, with a charging terminal 102 but may communicate with servers within the cloud infrastructure 160 by TCP/IP, LTE®, 3G, 4G®, 5G™, or the like.

Each charging terminal 104 may include computing circuitry, an antenna, and memory (not shown) configured to receive a charging schedule from the charging system controller 150 through the access point 122 and use the charging schedule to deliver power to a battery of the respective vehicle (102₁, 102₂, 102₃, . . . ,102_{E}). Alternatively, the communications could be sent over a wired Ethernet connection and the antenna could be eliminated.

The charging system controller 150 may be a virtualized computer accessing virtual physical computing and processing resources from a variety of physical computers, processors, routers, servers, and the like, stored in multiple geographical locations. The charging system controller 150 includes computer instructions for calculating a pricing policy. Alternatively, the pricing policy may be calculated by a pricing policy processor in communication with the charging system controller 150.

The charging system controller 150 may be further configured to communicate with databases or application programming interfaces (APIs), within or external to the cloud 160 to access higher-level processing programs, historical charging records, energy supplier current service rates, energy incentives, or the like.

The charging terminal 104ᵢ may include computing circuitry and a memory (not shown). The computing circuitry may be implemented as one or more microprocessors, microcomputers, microcontrollers, digital signal processors, central processing units, graphical processing units, state machines, logic circuitries, and/or any devices that manipulate signals based on operational instructions. Among other capabilities, the computing circuitry may be configured to fetch and execute computer-readable instructions stored in the memory. In an aspect of the present disclosure, the memory may include any computer-readable medium known in the art including, for example, volatile memory, such as static random access memory (SRAM) and dynamic random access memory (DRAM) and/or nonvolatile memory, such as read-only memory (ROM), erasable programmable ROM, flash memory, hard disks, optical disks, and magnetic tapes. The memory may be capable of storing data and allowing any storage location to be directly accessed by the computing circuitry.

The charging system controller 150 is preferably a virtual machine accessed in a cloud computing environment, such as an application server. The charging system controller 150 may include processing resources configured to operate the system 100, receive data from a personal computing device of a driver, receive data from the optional pricing policy processor, receive statistical information from the data center 162, a subscriber database 164, and the like. The cloud computing infrastructure 160 may include an application server which hosts an application which performs some or all of the processes of the pricing policy. A server within the cloud computing infrastructure may include a communication endpoint or find other endpoints and communicate with those endpoints. The server may share computing resources, such as CPU and random-access memory over a network. The server may be a virtual server.

As shown in FIG. 1B, each driver uses a personal computing device (103₁, 103₂, 103₃, . . . , 103_{E}), e.g., a smartphone, a tablet, a personal computer connected to a hotspot, or the like, to interact with the charging system controller 150 through a native application or through a website. The personal computing device may have downloaded a native application configured to access the pricing policy for the charging system. Alternatively, the personal computing device may have registered with a website configured to compute the pricing policy. The personal computing device may interact with the charging system controller 150 over communication paths (113₁, 113₂, 113₃, . . . , 113_{E}).

When the personal computing device downloads the native application and registers with the native application, and/or communicates through the website, data such as vehicle make, vehicle model, vehicle manufacturing year, current mileage, type of charging port may be required from the driver, as well as payment information. The charging system controller 150 may access user information and information about the vehicle from the subscriber database 164. The user information may include payment information and identification information.

A charger network with tens of thousands of charging terminals may be aggregated to enable participation of the charging terminals as a “virtual power plant” in the wholesale energy market for providing demand response and other grid services.

FIG. 1C shows an exemplary map of N charging stations 100ₙ (n=1 to N), which may be operated by a service provider. Each charging system may have a plurality of charging terminals 104ᵢ, and there may be a plurality of charging stations 100ₙ. The charging system controller 150 aggregates pricing tariffs, type of energy (utility grid, solar, wind, or the like), power incentives, availability of charging terminals within a user's location, and the like, and may process this data to determine a set of pricing options for each user, or may send this data to a pricing policy processor). Each user 103₁ at a charging station 100ₙ may thus communicate directly with the charging system controller 150 via cloud server 165 to receive the pricing options on the user interface of his/her personal computing device.

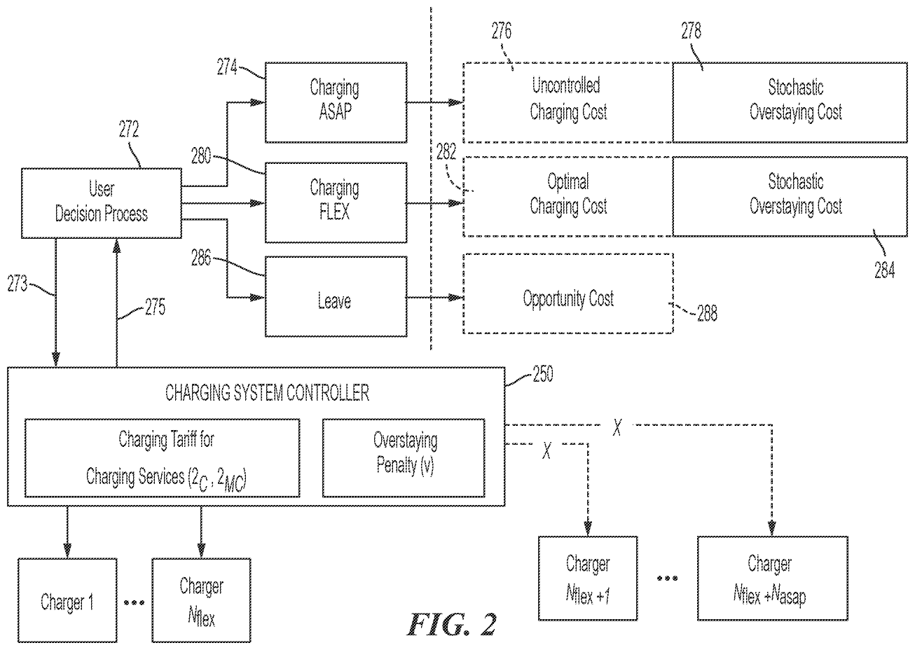

FIG. 2 is a diagram illustrating a PEV charging station work-flow of the station operation and proactive interaction with new users, for example, via a charging system controller 250. When a user accesses the native application or website, the user (e.g., at user decision process 272) may input an intended parking duration and a desired added range in miles or kilometers, e.g., via communication 273, or may be requested to input the same from charging system controller 250, e.g., via communication 275. The charging system controller 250, like charging system controller 150 shown in FIGS. 1A and 1B, may send the user inputs to a pricing policy processor, or may include computer instructions for calculating a pricing policy. The charging system controller 250 also accesses vehicle information, such as battery capacity, and vehicle make and model, from a subscriber database (e.g., subscriber database 164 shown in FIGS. 1A and 1B) or automatically through a vehicle data communications standard such as ISO 15118 or vehicle telematics data via application programming interface (API). The charging system controller 250 receives the user inputs 273 and vehicle data, accesses utility tariffs from memory or from a data center (e.g., data center 162 shown in FIGS. 1A and 1B), and determines optimized pricing options for all the vehicles docked into the charging terminals based on the user inputs and vehicle data. The optimized pricing includes the options for immediate charging (charging-ASAP 274) and longer-term charging where the charging system controller can manage the charging schedule and power transfer (flexible charging, or charging-FLEX 280). Upon receiving the user choice of a pricing option, the charging system controller 250 may generate a charging schedule for each charging terminal, which is configured to manage the charging of every docked vehicle via Charger 1, . . . ,Charger N_{flex}, Charger N_{flex}, +1, . . . , Charger N_{flex}+Nₐₛₐₚ, in order to optimize profitability and throughput of the charging station.

The pricing option for overstaying PEVs is evaluated differently in the two charging options, defined above as charging-ASAP 274 or charging-FLEX 280. Upon arrival, the user or customer first submits the amount of energy needed and/or desired parking duration to the charging system controller 250, e.g., via communication 273 as described above. This information also may be estimated by the charging system controller 250 (and/or via a threessor), based on data previously provided by the customer, historical charging station utilization patterns, and/or vehicle data, such as current and historical battery state of charge, driving speed, geolocation, and other data. Similar to the charging system controller 150, the charging system controller 250 may also include a non-transitory computer readable medium having instructions stored therein that, when executed by a processor, calculate a pricing policy to generate the pricing options for the user (e.g., charging tariff for charging services, and overstaying penalty(v)), where the pricing options include charging-ASAP 274, charging-FLEX 280, or the user may decide to leave without charging at no cost (e.g., leave 286). The customer chooses a pricing option, and the charging system controller 250 generates the charging schedule.

For example, if charging-ASAP 274 is chosen, the PEV driver pays for any overstay duration subsequent to the requested charge. If charging-FLEX 280 is chosen, then the overstay cost is not applied until after the stated parking duration. For example, the charging schedule for charging-FLEX 280 may include consecutive periods of different power levels transferred over the parking duration. From the perspective of a station operator, it is beneficial to encourage the longer-staying customers to accept the flexible charging option, charging-FLEX 280, to benefit economically by avoiding demand charges and by strategically scheduling charging profiles in a broader time window to avoid periods with high energy prices, especially for a charging station in which the charging terminals are not being fully utilized.

The nomenclature definitions and abbreviations for the equations used to determine the options are:

Inidices/Sets

T,t/ [symbol] Time index of the day

i/ [symbol] ₘ User set with service option m

i/ [symbol] User set at charging station, [symbol] = [symbol] _{flex}∪ [symbol] ₐₛₐₚ

m/ [symbol] Alternative/option set available at charging station. [symbol] ={flex, asap, leave}

Parameters

Δt Time step of the system, in [h]

Eᵢ^{req} Desired needed energy of user i, [kWh]

η Charger efficiency

p^{max} maximum charging power rate, in [kW]

Tᵢ Planned departure time of user i

ξᵢ Fixed overstay penalty for existing customer i, in [$/h]

ζᵢ Fixed charging price for existing customer i, in [$/kWh]

c_{D} Utility rule for demand charge, in [$/kW]

cₜ Utility rate for electricity at time t, in [$/kVh]

Variables

T^{overstay} Overstay duration, in [h]

∈_{i,t} Accumulative adder energy level for user i at time t, in [kWh]

p_{i,t} Charging power for user i at time t, in [kW]

yᵢ^{m} Per-unit overstay penalty for option m for user i, in [$/h]

zᵢ^{m} Per-unit price for option m for user i, in [$/kWh]

In the PEV charging station framework, users are presented with three options upon requesting charging services as shown in FIG. 2, e.g., charging-ASAP 274, charging-FLEX 280, and leave 286. Upon accessing a native application or a website of the charging station, a user i enters, or is presented with a request to enter, the following information: a planned departure time, Tᵢ, and/or a desired energy requirement, Eᵢ^{req}. The charging system controller 250 receives the inputs and generates a pricing menu, which includes a price for charging services plus an overstay price. The pricing menu presents the user with options based on the inputs:
charging-FLEX: zᵢ^{flex} and yᵢ^{flex}.
charging-ASAP: zᵢ^{asap} and yᵢ^{asap},
leave: zᵢ^{leave}(=0) and yᵢ^{leave}(=0),
   where zᵢ^{flex} represents the per-unit price for the flex option for user i, yᵢ^{flex} represents an overstay price which is not charged unless the vehicle does not leave after the planned departure time, zᵢ^{asap} represents the per-unit price for the asap option for user i, yᵢ^{asap} represents the overstay price, which is charged for any time after the charging has completed and the vehicle remains at the charging terminal, and zᵢ^{leave} and yᵢ^{leave} represent that the user may leave and there is no charge to the user.

The cost to the station operator for each choice is represented to the right of the dotted line flext to the three options (charging-ASAP 274, charging-FLEX 280, and leave 286) in FIG. 2. In an aspect of the present disclosure, the charging system controller 250 optimizes costs of operating the charging station for the station operator. In another aspect of the present disclosure, the charging system controller 250 optimizes costs for a network of charging stations, 100ₙ, e.g., as shown in FIG. 1C.

For the charging-FLEX 280 option, the charging system controller 250 optimizes the charging cost 282 based on changing energy tariffs and/or to maintain power demand below a desired threshold. For example, the power cost from 10 AM to 2 PM may be $A per kWh, and from 2 PM to 4 PM may be $B per kWh, where B<A. By charging the vehicle from 2 PM to 4 PM at the lower rate, the charging system may be able to recover the cost due to the loss of access resulting from the longer time duration. The probability of the vehicle overstaying the planned departure time is included in the system cost optimization, as overstaying generates income but also diminishes throughput.

For the charging-ASAP 274 option, the charging cost 276 is not controlled, as the energy is delivered at the maximum rate until the vehicle battery reaches the charge level necessary to attain the desired range. For a charging station at full capacity, the cost of a vehicle overstaying is the opportunity cost associated with the inability to provide charging services to a newly arrived vehicle. The stochastic overstay cost (278, 284) may be priced at a higher rate in the charging-ASAP 274 option, to encourage the driver to remove the vehicle from the charging terminal.

If the user chooses to leave 286, the charging system experiences a loss of revenue due to the time it takes for another vehicle to dock to the charging terminal. This expected loss of revenue is included in the pricing policy cost optimization as an opportunity cost 288 to the station.

Each option on the pricing menu is further described below with respect to the energy level evolution of the PEV.

In the present disclosure, charging-FLEX means that the user grants flexibility to the station operation, for controlling the charging schedule. The station controller transmits a charging schedule to each charging terminal to ensure the needed energy is delivered by user's stated departure time. When a user selects charging-FLEX, he/she provides two constraints:
E_{req,i}: requested kWh added (or presented to the user as requested miles added)
Tᵢ: a planned departure time. This imposes a deadline to supply the aforementioned requested kWh of energy.

Let i∈ [symbol] _{flex} be the index of PEVs charging via the FLEX service. [symbol] _{flex} represents a subset of users who have chosen the FLEX option. The PEV energy level constraints are defined as:

e_{n,T}_{₀}^{flex}=0 (1)

e_{i,t+1}=e_{i,t}+Δt·η·p_{i,t}∀i∈ [symbol] _{flex}, (2)

Eᵢ^{req}≤e_{i,T}_{ᵢ}, (3)

0≤p_{i,t}≤p^{max}, (4)

where ηϵ[0, 1] is the charger's efficiency.

In the present disclosure, charging-ASAP means that energy is delivered to the PEV battery continuously at the same power level until the desired amount of energy has been delivered. In this pricing choice, no time flexibility is permitted. The charging power is set to maximum throughout the charging session until the vehicle is unplugged, the desired amount of energy has been delivered, or its battery is fully charged. It is assumed that the required energy delivery does not exceed the PEV battery capacity, i.e. Eᵢ^{req}≤Eⱼ^{batt}.

When a user selects charging-ASAP, only one constraint: E_{req:j}, is required, which is defined as the requested kWh added and which may be presented to the user as the number of miles or kilometers added to the existing range of the vehicle. E_{req:j} may also be estimated.

The constraints are as follows: let j∈ [symbol] ₐₛₐₚ be the index of PEVs charging via the E charging-ASAP option. Thus:

e_{j,t+1}=e_{j,t}+Δt·η·p_{j,t}∀j∈ [symbol] ₐₛₐₚ, (5)

p_{j,t}=p^{max}, for t=0,1, . . . ,Tⱼ (6)

In this case, the user indicates how much energy must be delivered. The charging terminal provides full power until this requested amount of energy is delivered. The number of time steps to deliver this power can be calculated as shown in equation (7):

$${T}_{j} = \frac{{E}_{j}^{req}}{Δ t \cdot η \cdot {p}^{m ax}} . \qquad ( 7 )$$

In the present disclosure, Leave means the user does not accept either charging-ASAP or charging-FLEX, and leaves without charging. When a user decides to Leave, e.g., leave 286, then there are no added costs to the user. A charging service for leaving may be presented as leave 286, alternately the user may remove the vehicle from the charging terminal and/or close the computer application without making a leave selection. However, the station operator is subject to a service opportunity cost 288 by losing one customer.

Overstay Modeling

The overstay duration is modelled as random, T_{overstay}, and is dependent on the overstay price, γ. Considering a conditional probability model for overstay duration:

Pr(T_{overstay}=t|y) (9)

Intuitively, as pricey increases, the conditional probability distribution will shift towards shorter overstay durations. Thus, the expected revenue from overstay is given by:

Λ(y)=y· [symbol] (T_{overstay}|y] (10)

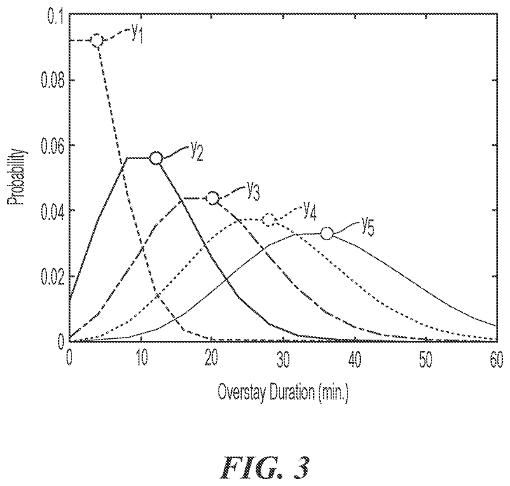

which has units of U.S. dollars (USD), but could be units of any currency. For example, FIG. 3 represents a graph of equation (9), where y₁≤y₂≤y₃≤y₄≤y₅. The distribution shifts towards shorter overstay duration as the price increases.

Demand Charge Modeling

The demand charge is modeled by tracking the maximum total power consumption from start to the current time. The beginning of the control horizon is 0, which is the current time index. This can be tracked with the following dynamics:

$$\begin{matrix}\begin{matrix}{G}_{t} = {\sum }_{i ∈ {A}_{flex}} {v}_{i , t} + {\sum }_{j ∈ {A}_{asap}} {v}_{j , t} & ( total charging power ) \\ {G}_{t} ⪯ {G}_{m ax} & ( \begin{matrix}max power \\ constraint for station\end{matrix} ) \\ {D}_{t + 1} = max \{ {G}_{t} , {D}_{t} \} & ( peak power dynamics )\end{matrix} & \begin{matrix}\begin{matrix}( 11 ) \\ ( 12 )\end{matrix} \\ ( 13 )\end{matrix} \\ \begin{matrix}{D}_{t = 0} = {D}_{τ} & ( previous peak owner ) \\ {T}_{end} = max \{ {T}_{i} \vert i ∈ {𝒜}_{flex} ⋃ {𝒜}_{asap} ) & ( \begin{matrix}terminal time step of \\ PEV charge sessions\end{matrix} )\end{matrix} & \begin{matrix}( 14 ) \\ ( 15 )\end{matrix}\end{matrix}$$

Charging Spot Occupancy Dynamics

The occupancy dynamics for the charging terminals include stochastic modeling. The overstay duration is a conditional random variable, T_{overstay}|γ. The total number of time steps that a vehicle occupies a spot is Tᵢ+T_{overstay}|γᵢ.

PEV Charging Station Optimization Problem Formulation

The objective function is a weighted sum of profits on each service option that the incoming vehicle might select, over the control horizon.

The objective is to minimize the expected total costs, [symbol] , given by:

[symbol]

[f(z,y,u,m)]

=Pᵣ(M=flex)f^{flex}(z^{flex},y^{flex},p^{flex})

+Pᵣ(M=asap)f^{asap}(z^{asap},y^{asap})

+Pᵣ(M=leave)f^{leave},
which is the weighted sum of revenue, over the control horizon, for each service option that the user of the incoming vehicle might select. The weights are the probabilities of the user's selections.

However, the overall objective of the station operator or charging service provider is to maximize gross profit (i.e., gross revenue minus operational costs) and to minimize the expected total cost (i.e., operational costs minus gross revenue), with quality of service (QoS) taken into account. The QoS is later evaluated through the number of fulfilled service as well as the overstay duration. Random variables are user choice, M, and occupancy, w.

Therefore, the overall objective is to maximize an optimization formulation given by:

[symbol]

[f(z,y,u,M)]+Jₜₑᵣₘᵢₙₐₗ(ω_{T}) (16)

=Pᵣ(M=flex)f^{flex}(z_{flex},y_{flex},u_{flex},v) (Case 1:FLEX) (17)

+Pᵣ(M=asap)f^{asap}(zₐₛₐₚ,yₐₛₐₚ,uₐₛₐₚ,v) (Case 2:ASAP) (18)

+Pᵣ(M=leave)f^{leave}(z_{flex},zₐₛₐₚ,yₐₛₐₚ,u_{flex},uₐₛₐₚ,V) (Case 3:LEAVE) (19)

+Jₜₑᵣₘᵢₙₐₗ(ω_{T}) (profit-to-go) (20)

where [symbol] [f(z, y, u, M)] is the expected gross profit, Jₜₑᵣₘᵢₙₐₗ(wᵣ) is the operational cost of the charging station, M is the set of pricing options, z is a per-unit price of charging for each pricing option of the set of pricing options, y is a per-unit overstay penalty for each pricing option of the set of pricing options, u is a charging power for a given pricing option selected by an incoming user, Pᵣ(M=flex) is a probability that the incoming user will select the charging-FLEX pricing option, f^{flex}(z_{flex}, y_{flex}, u_{flex}, v) is a function of a charging-FLEX profit of the charging-FLEX pricing option, zᵣᵢ is a per-unit price of the charging-FLEX pricing option, y_{flex} is a per-unit overstay price associated with the charging-FLEX pricing option, u_{flex} is a charging power for the incoming user for the charging-FLEX pricing option, V is a charging power for said each user, Pᵣ(M=asap) is a probability the incoming user will select the charging-ASAP pricing option, f^{asap}(zₐₛₐₚ, yₐₛₐₚ, uₐₛₐₚ, v) is function of an ASAP profit of the charging-ASAP pricing option, where zₐₛₐₚ is a per-unit price of the charging-ASAP pricing option, yₐₛₐₚ is a per-unit overstay price associated with the charging-ASAP pricing option, uₐₛₐₚ is a charging power for the incoming user for the charging-ASAP pricing option, Pᵣ(M=leave) is a probability the incoming user will leave without charging and f^{leave} is a function of an opportunity cost of the incoming user selecting to leave without charging.

TABLE 1
Optimization Variables

| Symbol | Description [unit] |
|---|---|
| zₘ | charge price for m [USD/kWh] |
| yₘ | overstay penalty for choice m [USD/hr] |
| u_{m,k} | charging power for choice m at time step k for new customer [kW] |
| v_{k,i} | charging power at time step k for existing customer i [kW] |
| Dₖ | peak power memory state for demand charges at time step k [kW] |
| Gₖ | total power imported from grid at time step k [kW] |

TABLE 2
Optimization Parameters

| Symbol | Description [unit] |
|---|---|
| cₖ | time-varying electricity cost from utility [USD/kWh] |
| Δk | time step duration [hrs] |
| ζᵢ | flex price for existing customers i [USD] |
| [symbol] ₘ | Set of indices for in-progress charging sessions with choice m |

In addition, constraints for each service option are considered:

subject to: (constraints for Case 1: Flex) (21)

(constraints for Case 2: ASAP) (22)

(constraints for Case 3: Leave) (23)

constraints common to all case) (24)

The constraints common to all cases are the in-progress charging-ASAP PEV, which are uncontrolled loads:

e_{j,t+1}=e_{j,t}+Δt·ηv_{j,t}∀j∈ [symbol] ₐₛₐₚ (25)

e_{j,t=0}=e_{j,τ} (26)

v_{j,t}=uₘₐₓ; for t=0,1, . . . ,Tⱼ (27)

This optimization runs each time a new vehicle arrives. Time r represents the absolute current time index, and t is a rolling time index over the control horizon. The station optimization problem considers the new customers (also referred to as incoming users) as well as the existing customers (also referred to as existing users). For existing charging-FLEX customers, the charging profiles will be re-evaluated to adapt to the new information and the changed environment. This is jointly considered in equations (18)-(20) when proposing price menu options to the new customer. For the in-progress charging-ASAP customers, no amendments are made and their charging profiles are considered uncontrollable loads, i.e., subject to the constraints common to all cases (24).

Case 1: Charging-FLEX

In Case 1, an incoming user selects the charging-FLEX option, and provides a requested kWh to be added to the user's battery charge, E_{req,flex}, and planned departure time, T_{flex}. In addition to the new vehicle of the incoming user, there are in-progress charging sessions for other PEVs. Let L, Tᵢ represent the absolute time index for each PEV's charging terminal time. The expected revenue over the control horizon is:

$$\begin{matrix}\begin{matrix}{f}^{flex} = {\sum }_{t = τ}^{{T}_{flex} - 1} ( \underbrace{{z}_{flex}}_{revenue} - \underbrace{{c}_{t}}_{{utility}_{rate}} ) Δ t \cdot {u}_{flex , t} & ( flex profit ) \\ + Λ ( {y}_{flex} ) & ( overstay profit ) \\ + {\sum }_{i ∈ {𝒜}_{flex}} [ \begin{matrix}{\sum }_{t = τ}^{{T}_{i}} ( {ζ}_{i} - {c}_{i} ) Δ t \cdot \\ {v}_{i , t}^{flex} + Λ ( {ξ}_{i} )\end{matrix} ] & ( \begin{matrix}profit for \\ in \text{-} progress flex \\ chg sessions\end{matrix} )\end{matrix} & \begin{matrix}\begin{matrix}( 28 ) \\ ( 29 )\end{matrix} \\ ( 30 )\end{matrix} \\ \begin{matrix} + {\sum }_{j ∈ {𝒜}_{asap}} [ \begin{matrix}{\sum }_{t = τ}^{{T}_{5}} ( {ζ}_{i} - {c}_{i} ) Δ t \cdot \\ {v}_{j , t} + Δ ( {ξ}_{j} )\end{matrix} ] & ( \begin{matrix}profit for \\ in \text{-} progress asap \\ chg sessions\end{matrix} ) \\ - {e}_{D} [ {D}_{{T}_{end}^{flex}} - {D}_{0} ] & ( \begin{matrix}marginal demand \\ charge\end{matrix} )\end{matrix} & \begin{matrix}( 31 ) \\ ( 32 )\end{matrix}\end{matrix}$$

subject to the energy constraints of equations (1) to (4). The power delivery for the in-progress charging-FLEX PEVs is re-optimized. However, the PEVs undergoing in-progress charging-ASAP are now fixed and uncontrollable loads, i.e., the power delivery is fixed. The prices for all in-progress PEVs are also fixed and uncontrollable.

The following constraints specific to Case 1: charging-FLEX are subject to:

e_{flex,t+1}=e_{flex,t}+Δt·η·u_{flex,t}(added energy dynamics) (33)

e_{flex,t=0}=0(initial energy delivered) (34)

e_{flex,T}_{ₖ}≥E_{req,k}(minimum miles added) (35)

0≤u_{flex,t}≤uₘₐₓ(EVSE power limits) (36)

and the constraints for the PEVs with in-progress charging-FLEX are:

e_{i,t+1}^{flex}=e_{i,t}^{flex}+Δt·η·v_{i,t}^{flex}∀i∈ [symbol] _{flex} (37)

e_{i,t=0}^{flex}=e_{i,T} (38)

e_{i,T}_{ₜ}^{flex}≥E_{req,i} (39)

0≤v_{i,t}^{flex}≤uₘₐₓ (40)

along with the charging-ASAP constraints:

$$\begin{matrix}\begin{matrix} {G}_{t}^{flex} = {u}_{flex , t} {\sum }_{i ∈ {𝒜}_{flex}} {v}_{i , t} + {\sum }_{j ∈ {𝒜}_{asap}} {v}_{j , t} & ( total charging power ) \\ {G}_{t}^{flex} ⪯ {G}_{m ax} & ( \begin{matrix}max power \\ constraint for station\end{matrix} ) \\ {D}_{t + 1}^{flex} = max \{ {G}_{t}^{flex} , {D}_{t}^{flex} \} & ( peak power dynamics )\end{matrix} & \begin{matrix}\begin{matrix}( 41 ) \\ ( 42 )\end{matrix} \\ ( 43 )\end{matrix} \\ \begin{matrix} {D}_{t = 0}^{flex} = {D}_{τ} & ( previous peak owner ) \\ {T}_{end}^{flex} = max \{ {T}_{i} \vert i ∈ {𝒜}_{flex} ⋃ {𝒜}_{asap} ⋃ flex ) & ( \begin{matrix}terminal time step of \\ PEV charge sessions\end{matrix} )\end{matrix} & \begin{matrix}( 44 ) \\ ( 45 )\end{matrix}\end{matrix}$$

where

$${\hat{T}}_{j} = \frac{{E}_{j}^{req} - {e}_{j , t}}{Δ t \cdot η \cdot {p}^{ma x}} ,$$

is the updated departure time index from the remaining needed energy of user j. During this process, the charging profile for the PEVs with in-progress charging-FLEX is re-optimized. However, those in-progress charging-ASAP PEVs are restrained from re-optimization, as they are modelled as uncontrollable loads. The prices for all in-progress PEVs are locked down and fixed through their charging session.

Case 2: Charging-ASAP

In Case 2, the incoming user chooses the charging-ASAP option and provides a requested kWh to be added to the user's battery charge, E_{req,asap}, and the controller directly calculates a terminal charge time, Tₐₛₐₚ. If the user chooses this service option, the planned departure time will be enforced, i.e., Tₙ=Tₙ^{asap}. In addition to the incoming user, there are in-progress charging sessions for other PEVs. In this setting, L, Tⱼ represent the absolute time index for the charging terminal time of each PEV. The expected revenue over the control horizon is:

$$\begin{matrix}{f}^{asap} = {\sum }_{t = τ}^{{T}_{asap} - 1} ( \underbrace{{z}_{asap}}_{revenue} - \underbrace{{c}_{t}}_{utility rate} ) Δ t \cdot {u}_{asap , t} + ( asap profit ) & ( 46 ) \\ Λ ( {y}_{asap} ) + ( overstay profit ) & ( 47 ) \\ {\sum }_{i ∈ {𝒜}_{flex}}^{ } [ {\sum }_{t = τ}^{{T}_{t}} ( {ζ }_{t} - {c}_{t} ) Δ t \cdot {υ}_{i , t}^{asap} + Λ ( {ξ}_{i} ) ] + ( profit for in \text{-} progress flex chg sessions ) & ( 48 ) \\ {\sum }_{j ∈ {𝒜}_{asap}}^{ } [ {\sum }_{t = τ}^{{T}_{j}} ( {ζ }_{j} - {c}_{t} ) Δ t \cdot {υ}_{j , t} + Λ ( {ξ}_{j} ) ] - ( profit for in \text{-} progress asap chg sessions ) & ( 49 ) \\ {c}_{D} [ \text{?} - {D}_{0} ] ( marginal demand charge ) \\ \text{?} \text{indicates text missing or illegible when filed} & ( 50 )\end{matrix}$$

subject to the energy constraints of equations (5)-(7).

Note that the power for the PEVs with in-progress charging-flex can be re-optimized. However, the PEVs with in-progress charging-ASAP are fixed and uncontrollable loads. Alternatively, the prices for all in-progress PEVs can also fixed and uncontrollable, and the optimization applies only to the PEV of the incoming user.

The following constraints are specific to Case 2: charging-ASAP, subject to:

e_{asap,t+1}=e_{asap,t}+Δt·η·u_{asap,t}(added energy dymanics) (51)

e_{asap,t=0}=0(initial energy delivered) (52)

u_{asap,t}=uₘₐₓ for t=0,1, . . . ,Tₐₛₐₚ (53)

and the constraints for the in-progress flex PEVs:

e_{i,t+1}^{asap}=e_{i,t}^{asap}+Δt·η·v_{i,t}^{asap}∀i∈ [symbol] _{flex} (54)

e_{i,t=0}^{asap}=e_{i,τ} (55)

e_{i,T}_{ₛ}^{asap}≥E_{req,i} (56)

0≤v_{i,t}^{asap}≤uₘₐₓ (57)

along with the demand charge constraints:

$$\begin{matrix}{G}_{t}^{asap} = {u}_{asap , t} + {\sum }_{i ∈ {𝒜}_{flex}}^{ } {υ}_{i , t}^{asap} + {\sum }_{j ∈ {𝒜}_{asap}}^{ } {υ}_{j , t} ( total charging power ) & ( 58 ) \\ {G}_{t}^{asap} \leq {G}_{max} ( max power constraint for station ) & ( 59 ) \\ {D}_{t + 1}^{asap} = max \{ {G}_{t}^{asap} , {D}_{t}^{asap} \} ( peak power dynamics ) & ( 60 ) \\ \text{?} = {D}^{T} ( previous peak power ) & ( 61 ) \\ {T}_{end}^{asap} = max \{ {T}_{i} \vert i ∈ {𝒜}_{flex} ⋃ {𝒜}_{asap} ⋃ asap \} ( terminal time step of PEV charge sessions ) & ( 62 ) \\ \text{?} \text{indicates text missing or illegible when filed} & \end{matrix}$$

Case 3: LEAVE

The opportunity cost when the user leaves is the expected revenue as if the user had selected either charging-FLEX or charging-ASAP. The reasons for leaving may include, but are not limited to any one of being unsatisfied with charging prices, high penalty of overstay, and the like. By keeping the formulation of the entire objective function multi-block convex, this opportunity cost is computed as follows:

$${f}^{leave} = - Pr ( Λ f = flex ) \cdot {f}^{flex} ( {z}_{flex} , {y}_{flex} , {u}_{flex} , υ ) - Pr ( M = asap ) \cdot {f}^{asap} ( {z}_{asap} , {y}_{asap} , {u}_{asap} , υ = \text{?} ( {c}_{k} - 0 ) \cdot {p}^{max} \cdot Δ t . \\ \text{?} \text{indicates text missing or illegible when filed} \qquad ( 63 )$$

It can be observed that equation (63) does not account for the net cost/revenue that may occur because the charger is now available, instead of occupied. However, the opportunity cost may be calculated differently to account for this.

Discrete Choice Model (DCM) for Behavioral Modeling

From a station operator's or charging service provider's point of view, each charging option is associated with a specific operation cost (e.g., overstaying cost 278 or 284, or opportunity cost 288). The effectiveness of capturing the decision process of users dictates the service pricing policy. To quantitatively evaluate these behaviors, DCM is adopted. DCM is a successful modeling technique for analyzing human behaviors when their choice options are limited to a discrete space. A representative model is a “multinomial logit model,” which assumes each choice option is independent and choice probabilities follow a sigmoid function. The multinomial logit model is used in the pricing policy.

In DCM, the preference as to each choice option is quantified by a utility function, and an alternative is chosen when its utility is greater than that of others. Formally, for the kth alternative, k E {1, 2, . . . , K}, the utility function is

Uₖ≐Bₖ^{T}zₖ+yₖ^{T}wₖ+β₀ₖ+ϵₖ, (64)

Here, z is the set of “incentive controls”, w is the set of exogenous variables (i.e., variables not affected by other variables in the system), βₖ and γₖ are weights for the controllable inputs and uncontrollable inputs, respectively, β₀ₖ is named the “alternative specific constant”, and a latent variable Eₖ accounts for any unspecified errors.

In the context of the charging system, the service prices and the overstay penalty are the “incentive controls,” and the time-of-the-day, parking duration, battery capacity, initial SOC, and needed energy are the exogenous variables, where:

Uⱼ: Utility of j-th alternative, j E {asap, flex, leave}

βⱼ: Parameters of controlled attributes

zⱼ: Controlled attributes

γⱼ: Parameters of UN-controlled attributes

wⱼ: Uncontrolled attributes

β₀ⱼ: Alternative specific constant

εⱼ: Undefined errors

The probability of the jth alternative, Pᵣ, being chosen is captured with the multinomial logit model is given by:

$$Pr ( alternative j is chosen ) = \frac{{e}^{{V}_{j}}}{{\sum }_{n = 1}^{M} {e}^{{V}_{n}}} , \qquad ( 65 )$$

where

$${V}_{j} \mathring{=} {β}_{j}^{T} {z}_{j} + {γ}_{j}^{T} {w}_{j} + {β}_{0 j} .$$

finis model is non-convex in Z.

Referring to equation (64), for the statistical model for three discrete user choices, indexed by m E {flex, asap, leave}= [symbol] , each choice has a perceived utility, therefore Uᵣₙ is given by:

Uₘ=βₘ^{T}zₘ+yₘ^{T}wₘ+β₀ₘ+ϵₘ (66)

where zₘ is the controllable input (i.e., price), wₘ are uncontrollable inputs (i.e., time-of-day, day-of-week, etc.). The weights βₘ, βₒₙᵢ, yₘ are determined by fitting to data, for example, to collected data from previous charging sessions. Finally, Eᵣₙ is perception noise, which is white noise at the perceived utility.

If ϵₘ has an extreme value distribution, then the probability of user choice has the form:

$$Pr ( M = m ) = \frac{exp ( {V}_{m} )}{{\sum }_{n ∈ ℳ}^{ } exp ( {V}_{n} )} = \frac{exp ( {β}_{m}^{T} {z}_{m} + {γ}_{m}^{T} {w}_{m} + {β}_{0 m} )}{{\sum }_{n ∈ ℳ}^{ } exp ( {β}_{n}^{T} {z}_{n} + {γ}_{n}^{T} {w}_{n} + {β}_{0 n}} \qquad ( 67 )$$

where Vₘ+βₘ^{T}zₘ+γₘ^{T}wₘ+β₀ₘ is the utility without perception errors. Note that the choice probabilities depend on the prices zₘ in a nonlinear way.

Table 3 shows an example charging schedule for a charging station that has four terminals occupied by vehicles.

TABLE 3
Example Schedule

| | | | Planned | | | |
|---|---|---|---|---|---|---|
| | Arrival | kWh | Depart | | Actual | |
| ID | Time | requested | Time | Choice | Departure | Overstay |
| 1 | 07:00 | 10 kWh | 1 6:00 | flex | 17:00 | 1.0 hr |
| 2 | 08:00 | 10 kWh | 12:00 | flex | 12:00 | 0.0 hr |
| 3 | 09:00 | 25 kWh | 17:00 | asap | 18:00 | 1.0 hr |
| 4 | 10:00 | 15 kWh | 13:00 | ? | ? | ? |

Assumptions

[A1] All users follow the same behavioral model. They follow the same process as described with reference to FIG. 2 when deciding on service options. This can be easily relaxed by clustering users into archetypes, and then assuming each user falls within an archetype.

[A2] The three alternatives are probabilistically independent, which is a fundamental assumption of the multinomial logit model.

[A3] At time of incoming, each user chooses at least and at most one alternative among the three choice options.

[A4] Each user is rational and selfish, in order to maximize his/her individual utilities.

[A5] DCM parameters are deterministic, i.e., the station operator has collected sufficient observations on user's decisions to identify an accurate DCM.

[A6] Demographic information of a user is unknown, i.e., only measurable data is utilized as attributes in the DCM Logit Model.

Assuming “perception” errors, ϵ_j, have independent and identically distributed (i.i.d.) extreme value distributions, the probability of choosing the j-th alternative is:

$$Pr ( alt j chosen ) = Pr ( {⋂}_{j \neq i} ( {U}_{j} > {U}_{i} ) ) = \frac{{e}^{{V}_{j}}}{{\sum }_{i = 1}^{J} {V}_{i}} = sm ( V )$$

where Vⱼ=βⱼ^{T}zⱼ+γⱼ^{T}wⱼ+β₀ⱼ.

Model Specifications for Charging Options

Survey Preference (SP) data was collected in a survey of 50 participants. The questions ranged from charging choices at specific scenario settings to user specific social-economic attributes. The questions included initial energy level, energy need, staying duration, price, attitude towards sustainable energy, income, age, education level, etc. The parameters were estimated with a maximum likelihood estimation by a related tool, PyLogit. PyLogit is a Python® package for performing maximum likelihood estimation of conditional logit models and similar logit-like models. The respective “p-values” were calculated as a reference of statistical importance. As a result, charging price was identified as the statistically important incentive control input, and initial energy level and energy need as the statistically significant exogenous variables. This multinomial logit model was adopted to model a user's decision process when designing the pricing scheme for the station operation. It can be observed that this model specification relies heavily on the collected sample set. Relative to starting without any prior knowledge, this represents a reasonable starting point. In practice, as the station operator collects more user decision data, the model parameters may evolve and be updated.

This optimization runs each time a new vehicle arrives and requests service. The station optimization problem considers the new as well as the existing customers in one operation. For existing charging-FLEX customers, the charging profiles are periodically reevaluated to adapt to new information and changes in the environment, such as changes in cost of power, the number of charging-FLEX customers, the duration of each charging-FLEX customers, and the like. This will be jointly considered in Eqn. (18)-(20) for the objective function when proposing price options to the new customer. For the in-progress charging-ASAP customers, no amendments are made and their charging profiles are considered uncontrollable loads, i.e., subject to the constraints common to all cases as shown by equation (24).

Within a control horizon, T is used to index the rolling time step and tis used as the global time index.

To describe formulations in a compact form, a long array x is denoted, which consists of new and existing customers charging profile, p_{i,l} and the corresponding constraints e_{i,t}, {i|∈ [symbol] _{flex}∪n},{t|t=1, 2, . . . T_{end}^{flex}}.

Reformulation into the Multi-Convex Problem

The non-convex original form of the problem cannot be solved efficiently with standard off-the-shelf solvers. This is due to the highly non-linear and non-convex structure of the model structure (equations (16)-(20)). A transformation methodology is used to yield a three-block multi-convex structure. The resulting reformulation is then solved efficiently via BCD. This reformulation process and proof are detailed in Appendix A.

TABLE 4
Parameter settings of a PEV charging station

| Parameter | Value |
|---|---|
| Number of charging poles | 8 [EA] |
| Maximum charging power (each pole) | 7.2 [kW] |
| Operation hours | From 7 AM to 10 PM (15 hours) |

Numerical Simulations: Scenario Overview, Input Data Overview

For a case study, a real-world dataset from the PEV charging station at the Cal Poly San Luis Obispo campus in California was utilized. The data represented a charging demand (a total of 201 charging events) over a week from Jan. 16 to 23, 2019. In the dataset, the parking duration was 3.25 hours on average, while the charging duration was 2 hours on average. It can be observed that 38% of the parking duration was overstay.

The Pacific Gas & Electric A-10 Medium General Time-of-Use service was adopted for the time-of-use (TOU) price.

The infrastructure parameters of a charging station include: a number of charging terminals, maximum charging power at each pole, and operation hours. Each parameter was set as tabulated in Table 1.

A non-limiting example of parameters of the DCM model are listed in Table 5. The general behavior tendencies reflected from the model include: (i) the higher the per-unit electricity prices imposed to customers, the greater the likelihood of leaving instead of staying to charge; (ii) the more energy the customers needed, the more likely they were to charge; and (iii) the longer the customers tended to stay, the more likely they were to charge and to choose charging-ASAP by default to maximize convenience.

TABLE 5
Weights of the Discrete Choice Model Parameters

| Parameter | Description | Value |
|---|---|---|
| β_{0,flex} | Alternative specific constant for charging-FLEX | 2.0 |
| β_{flex,E}^{req}_{·Price} | Needed energy × price for charging-FLEX | −0.1881 |
| γ_{flex,duration} | Stated parking duration for charging-FLEX | 0.401 |
| γ_{flex, SOCinit} | Initial SOC for charging-FLEX | −1.8531 |
| β_{0,asap} | Alternative specific constant for charging-ASAP | 1.0 |
| β_{asap,E}^{req}_{.price} | Needed energy × price for charging-ASAP | −0.1835 |
| γ_{asap,duration} | Stated parking duration for charging-ASAP | 0.865 |
| γ_{asap,SOCinit} | Initial SOC for charging-ASAP | −1.8531 |
| β_{leaving,overstay} | Overstay Penalty | 1.005 |

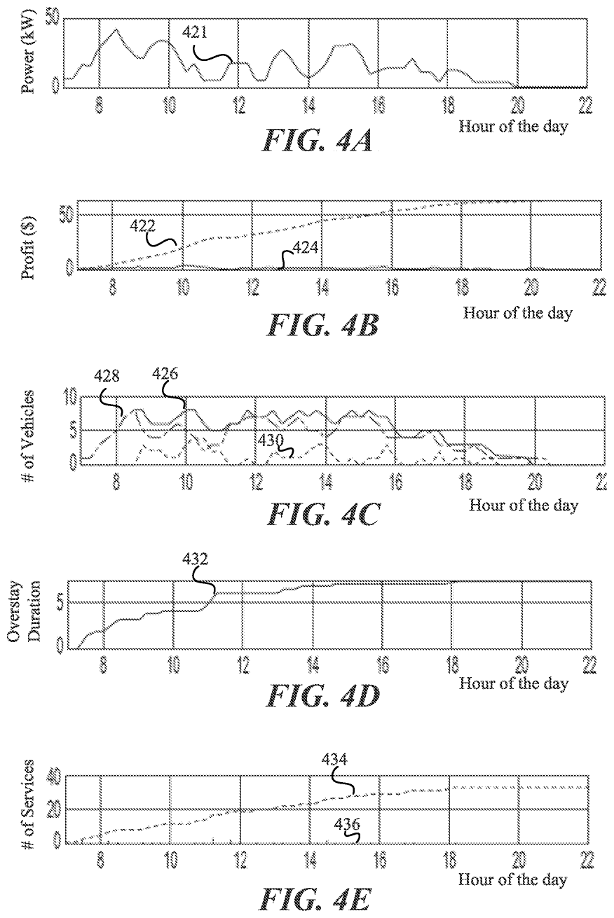

For a one-day operation, a set of charging events (a total of 50) was sampled from an empirical distribution of charging events generated from the dataset. From the pricing options, which depended on the charging prices and the overstay penalty, each user made a decision to whether charge or leave, and with which service to charge. Both the charging price and overstay penalty were optimally determined online by the pricing controller. An overview of the results is shown in FIGS. 4A-4E, which demonstrate an hourly temporal profile 421 for one episode of the charging station's power profile, showing peaks of power used between 8 AM and 10 AM and again between 2 PM and 4 PM (FIG. 4A), net profit 422 and instantaneous profit 424 curves (FIG. 4B), overall occupancy curves for total occupancy 426, charging occupancy 428 and overstay occupancy 430 (FIG. 4C), accumulated overstay duration curve 432 (FIG. 4D), and the net number 434 of PEVs served and the instantaneous number of PEVs served 436 (FIG. 4E), aggregated over all charging terminals.

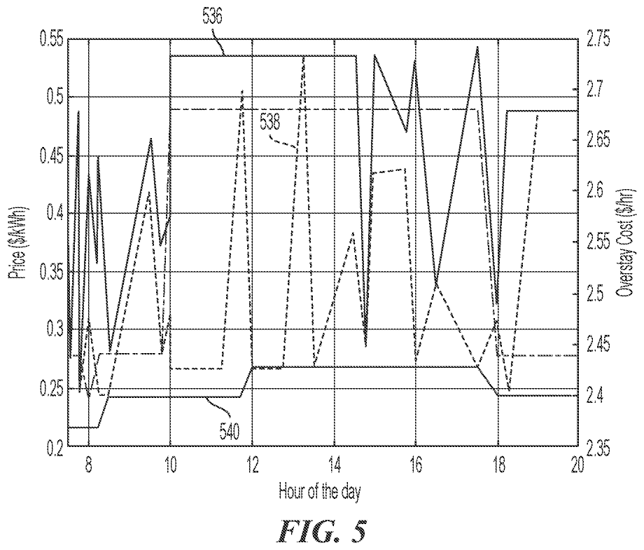

FIG. 5 is a graph showing a breakdown of details including the real-time variations of the optimal prices for charging-ASAP 536, charging-FLEX 538, and time-of-use 540.

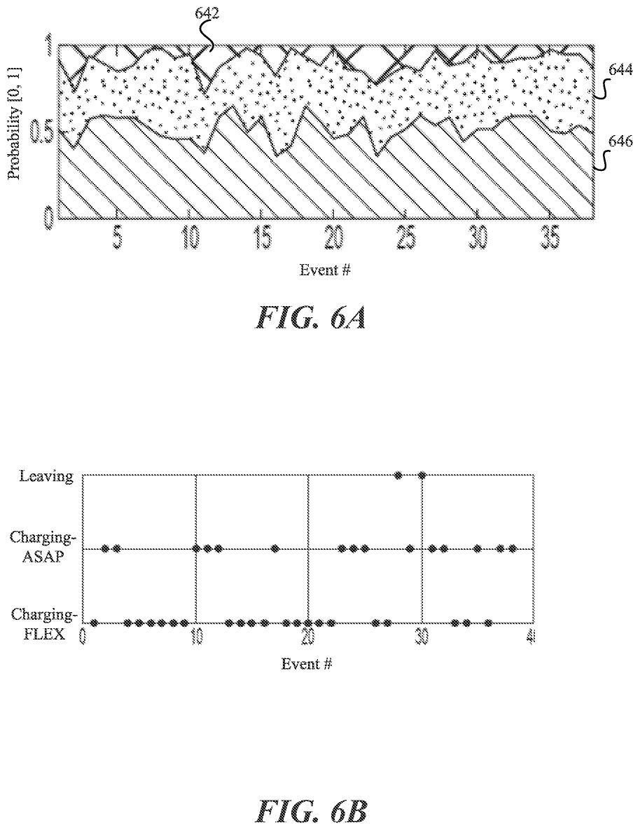

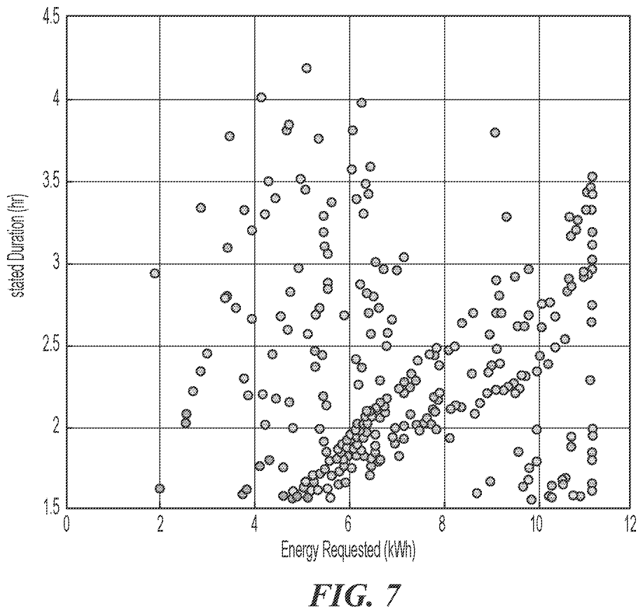

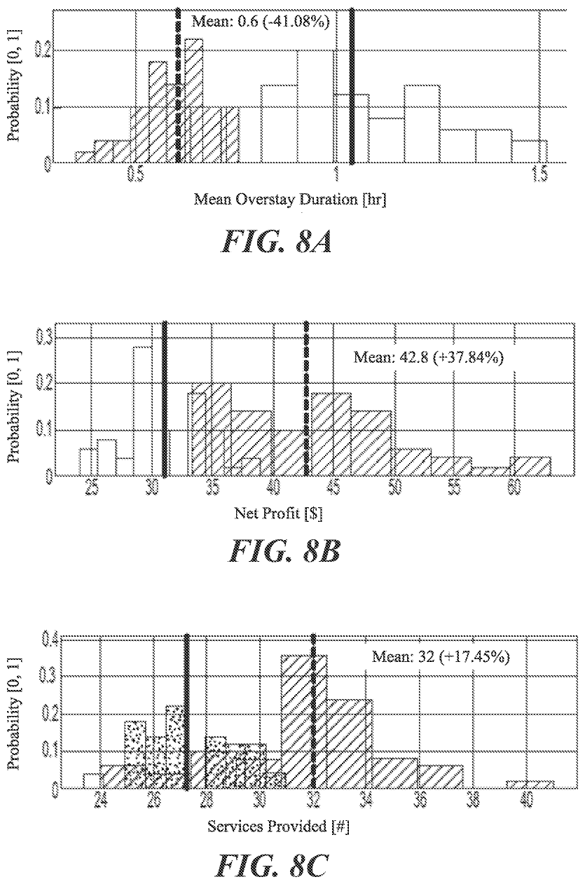

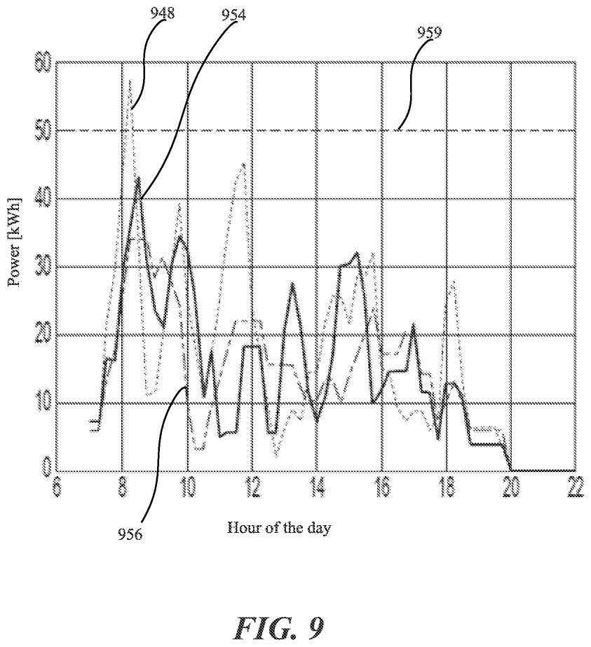

FIGS. 6A-6B show the resulting variations of the user decision process. To concretely quantify the performance of the station controller (i.e., charging system controller 150 or charging system controller 250 as described previously), three metrics are considered: (i) overstay duration, (ii) total net profit, and (iii) quality-of-service, measured by the number of PEVs served (see, e.g., FIGS. 7 and 8 described below). The effectiveness of peak power management is illustrated in the results at the station level, which will be described with reference to FIG. 9 below. Last, a sensitivity analysis was conducted on the manner in which station size impacts the total profit and the QoS.

All parameters considered were tested for statistical significance, except γ_{flex, duration} and γ_{asap, duration}. This is simply a starting point of the model specifications; as more data is collected from the real world setting, the coefficients γ_{flex, duration} and γ_{asap, duration} may be estimated and updated online.

Referring back to the graph of FIG. 5, the trajectories of charging prices and overstay penalty based upon TOU price are shown. The optimizer heavily discounts charging-FLEX (538) relative to charging-ASAP (536) when customers stay through the peak hours (12:00-17:00), that is, when the TOU price is high. For example, a customer may arrive at 10:00, when the price for charging-FLEX (538) is $0.26/kWh, which is greater than a 51% discount compared to charging-ASAP (536). This incentivizes the customer to select charging-FLEX, which gives the station operator the charging flexibility to minimize power and consequently costs to the station operator during the peak period of the TOU (540).

FIGS. 6A and 6B show how the probability of a user choosing a given option among the choice options varies over time. The users' utility functions (equation 64) are subject to factors such as price variations, needed energy, stated duration, and the like. The users exhibit a natural tendency towards charging-ASAP (region 644) over charging-FLEX (region 646), and of choosing either charging-ASAP or charging-FLEX over leaving (region 642). However, as shown in FIG. 6B, it was observed that this tendency can be influenced using the controller's price incentives, as more users selected charging-FLEX than charging-ASAP. Since a greater number of charging-FLEX choices were selected, the station operation was provided with power management opportunities to lower the overall cost of charging, in spite of the lower revenue from the charging portion of the charging schedule. It may be observed that only two users from the group left without charging.

A Pareto analysis was carried out to better understand how to set overstay penalty. This analysis also helped elucidate the relationship between the overstay penalty, the needed energy, and the stated parking duration (see FIG. 7). In FIG. 7, the dots represent the magnitude of the overstay penalty, from a small penalty (black dots) to a large penalty (gray shaded dots). The results show that there is a linear relationship (with R²=0:265) between the overstay penalty and the combination of the needed energy and the stated duration. That is, when a small amount of energy was requested along with a short stated parking duration, the overstay penalty is relatively small. In contrast, when both the requested energy and the stated parking duration were high, the overstay penalty was relatively large. This was an interesting consequence aligned with what was expected in the real world. When the user stayed at a charging station for only a short period of time, the user was more aware of the time, as the user needed to leave soon. Therefore, the overstay penalty was less effective in incentivizing the user to leave on time.

Monte Carlo simulations were performed to quantitatively validate the performance of the proposed price control, the results of which are shown in FIGS. 8A, 8B, and 8C. In FIGS. 8A, 8B, and 8C, each sample indicated charging during the course of a day. The total charging requests per day were set to 50. In each figure, the boxes with slashes represent controlled overstay (with price controller) and the solid boxes represent uncontrolled overstay (without price controller). The dotted vertical line represents the mean with control, and the solid vertical line represents the mean without control. FIGS. 8A, 8B and 8C show that the overstay duration decreased by 41.08% (FIG. 8A), the net profit increased by 37.84% (FIG. 8B), and the number of served events (QoS) increased by 17.45% (FIG. 8C), compared to the base case, which was without the pricing control. Due to an adjusted overstay penalty, the users tended to leave soon after their charging session completed to avoid the penalty. The decrease in the overstay duration allowed the charging station to accommodate more charging sessions and, consequently, increased the net profit.

As shown in FIG. 9, the effectiveness of the station-wide optimization approach of the present disclosure in power management was compared to a single-charger optimization approach. Curve 948 represents the single optimized charging terminal, curve 954 represents an optimized charging station with controlled charging, and curve 956 represents a single-charger without optimization. Dotted line 959 represents a baseline power. It was observed that power management across all charging terminal resulted in reducing the peak power (24.6% against single-charger optimization approach), which translated to a decrease in demand charge costs. The peak tariff was found to be between 12 PM and 5 PM. There was a significant discount for charging-FLEX versus charging-ASAP during or just prior to the peak hours. The lowest peak power is actually observed in the baseline case (curve 956) (i.e., without the price controller). However, as a result, the profit made by the station operator or system service provider was minimal (see, e.g., FIG. 8B), and higher costs may be passed on to the customers. With the decrease in maximum power usage, the station operator or system service provider can avoid investing in upgraded local electrical infrastructure. That is, the capital cost of installing more charging terminals and upgrading the station can be saved by managing the power profile.

Sensitivity Analysis

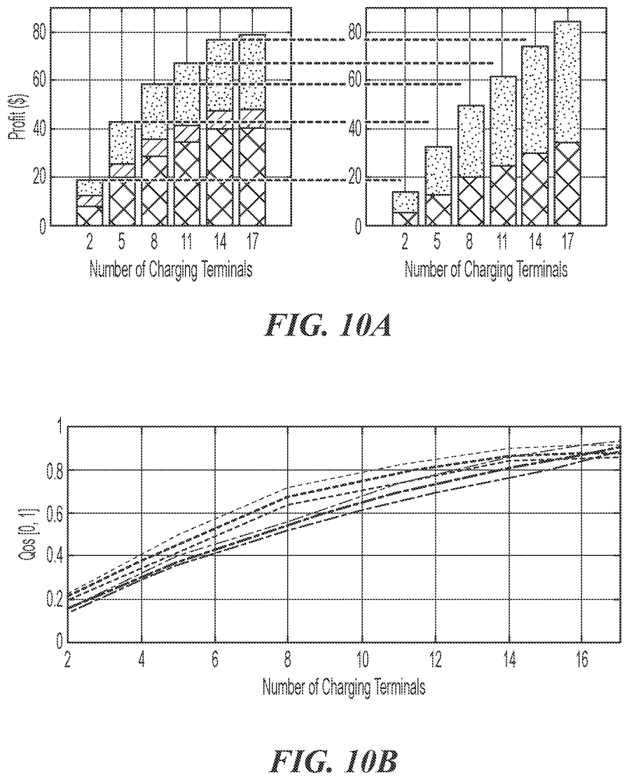

A sensitivity analysis was conducted on the total profit while varying the number of charging terminals. FIG. 10A illustrates how the total profit is segmented by charging service profit and overstay penalty. In FIG. 10A, the solid boxes represent charging-ASAP, the boxes with unidirectional slashes represent charging-FLEX, and the cross-hatched boxes represent overstay. The left graph in FIG. 10A represents the average profit distribution with incentive control, and the right graph in FIG. 10A represents the average profit distribution without incentive control. The horizontal dotted lines compare the differences in profit between the controlled and non-controlled stations for the number of charging terminals. FIG. 10B illustrates how the quality of service varies, where the upper three curves represent the controlled operation and the lower three curves represent the uncontrolled operation.

Note that the choice option of leaving does not exist in the baseline. That is, in the baseline, the customers are assumed to always use a charging service at arrival, without the possibility of refusing a service and leaving. Hence, the baseline is inherently able to provide a charging service with assurance when a charging pole is available, as opposed to the controlled case where a charging service can be refused with a certain probability.

There are two points to note from the graphs of FIG. 10A. First, overstay revenue is greater with incentive control than without, since the controller is explicitly increasing the overstay penalty to turnover PEVs and increase utilization. Second, in comparing the total profits with and without incentive control, for a small number of charging terminals, incentive control provides a greater profit. The reason is that there exists more PEV charging demand than charging terminals, creating congestion, which is managed by incentive control. When a sufficient number of charging terminals exist, there is no PEV charging demand congestion and thus pricing and charge scheduling does not increase profit. In fact, the overstay penalty can induce PEVs to leave, thus creating lost revenue.

Similarly, FIG. 10B illustrates how the quality-of-service varies with a different number of charging terminals. In general, the incentive control enables a station to provide more charging services. The improvement is a result of the reduced overstay duration, which frees the (formerly) occupied capacity to accommodate additional charging requests. However, as the number of charging terminals reaches 17, the QoS is out-performed by the baseline. This is due to a saturation effect that most of the demands have been successfully fulfilled by the system operation. (Leaving is not considered as an option in the baseline). On the other hand, the benefit of proper management compensates the leaving loss by reducing overstay duration of existing customers and accepting new ones.

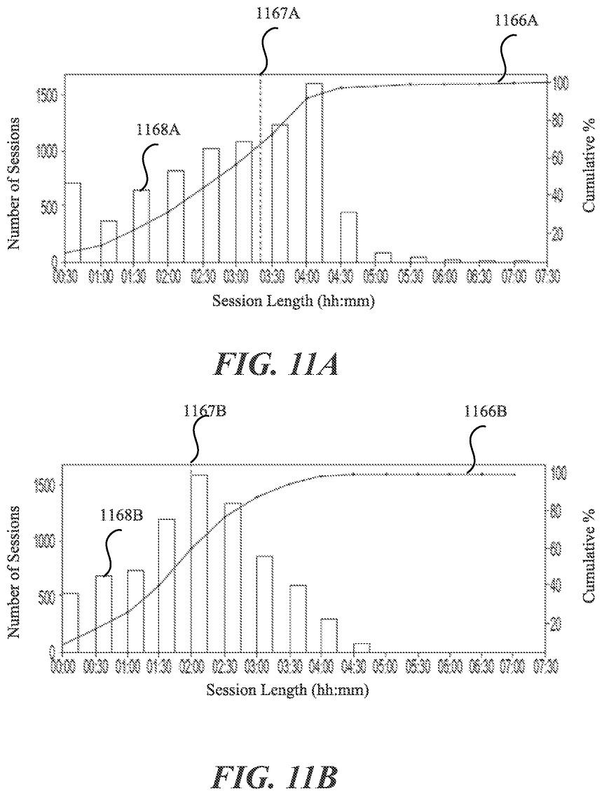

FIG. 11A illustrates the total duration in hours for a dataset of 703 charging sessions for 12 level 2 charging terminals (240V, 30A). The curve 1166A represents the cumulative percentage over the sessions, the dotted vertical line 1167A represents the average charging duration, and the histogram boxes 1168A represent the number of sessions during each time period. FIG. 11B illustrates the charging duration in hours. The curve 1166B represents the cumulative percentage over the sessions, the vertical line 1167B represents the average charging duration, and the histogram boxes 1168B represent the number of sessions during each time period. The average session time was approximately 3.5 hours and the average charging time was approximately 2 hours, with 1.5 hours overstay.

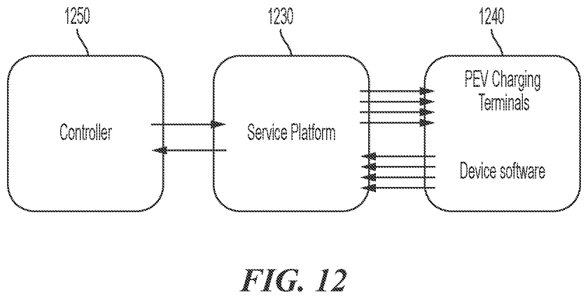

FIG. 12 shows an embodiment of the charging system control of a plurality of PEV charging terminals. The service platform 1230 may provide or exchange data with a website or a native application accessed by the user and which receives the user inputs. The service platform 1230 sends user inputs to the controller 1250, which uses the pricing policy to generate pricing options, which are sent back to the service platform 1230. The user chooses a pricing option, and the controller generates a charging schedule based on the chosen option, which is sent to the user's charging terminal among charging terminals 1240 through the service platform 1230. The charging terminals may communicate with the controller 1250 through the service platform to provide data pertaining to the charging operation.

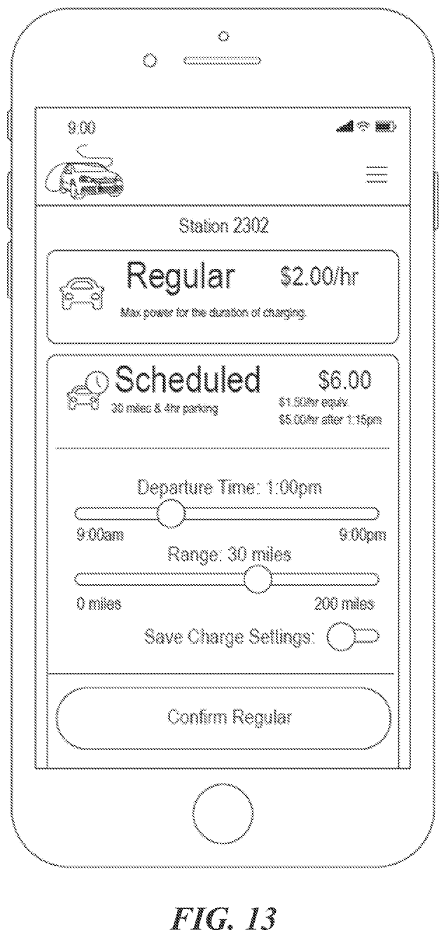

FIG. 13 is a non-limiting example of a charging interface, e.g., showing a website or a native application, which a user may see on his/her user device. The charging interface may show the time, the price for regular charging (e.g., charging-ASAP), pricing for scheduled charging (e.g., charging-FLEX), slider bars for adjusting the departure time and desired range, and a confirmation button.

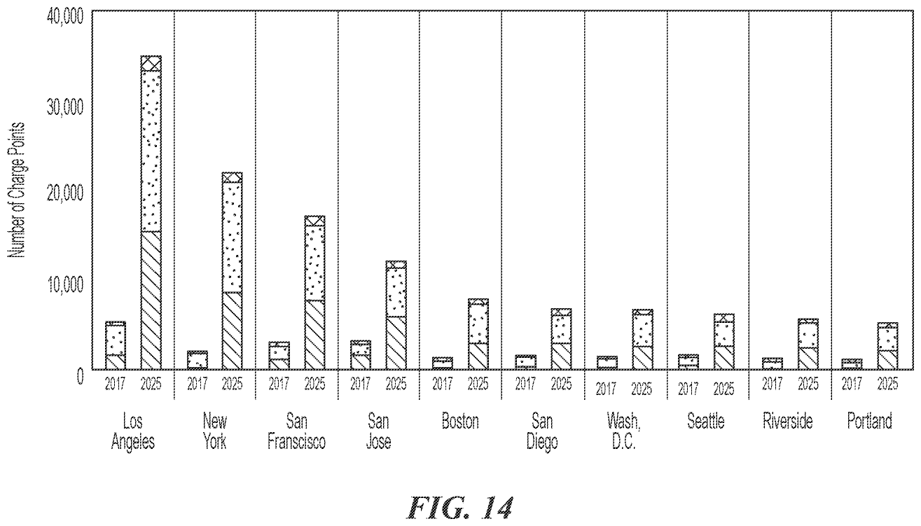

FIG. 14 is a histogram showing the number of charging terminals in different cities in the United States in 2017 compared to the estimated number of charge points needed by 2025. (See Nicholas, M., Hall, D., Lutsey, N., “Quantifying the Electric Vehicle Infrastructure Gap across U.S. Markets”, The International Council on Clean Transportation, January 2019, incorporated herein by reference in its entirety). In addition to adding charging terminals, maximizing the utilization of existing charging terminals may lower infrastructure costs incurred by charging station operators during this growth.

In summary, the qualitative and quantitative analyses show that: (i) incentive control has a strong potential in reducing overstay duration and securing additional profit as well as a curtailed peak power; and (ii) incentive control achieves a higher level of quality-of-service. These benefits degrade as the number of charging terminals increase relative to demand. However, these findings may guide infrastructure operators at the network planning stage, e.g., smaller station configurations can avoid excessive capital investment costs.

It is noted that an assumption behind the case study was that the behavior model in the optimization represents the generated choices in the simulations. This assumption can be validated if the DCM model accurately represents the actual choice behaviors. However, the validation relies on empirical research with human subjects in each specific application, since generalizability is not guaranteed. Nevertheless, it can be highlighted that this comparison shows a clear example of how to effectively use the behavioral dataset in a real control system (i.e., once enough data has been collected from a real world test bed).

Aspects of the present disclosure describe a mathematical framework to optimally operate a charging station with different charging service options. The objective of the operation is to reduce the overstay duration and to increase net profit, while considering a user's behavior in selecting charging service options. The framework leverages a DCM from behavioral economics to model a human choice probability, conditioned to a controllable charging and overstay cost. Due to the non-convexity and complex problem structure, the non-convex problem was reformulated to an equivalent multi-block convex problem, which may be solved efficiently through the BCD algorithm. In a case study, an agent-based simulation of a real-world charging demand dataset validated the charging system control framework. The simulation results demonstrate high potential of the model for alleviating the overstay duration, increasing net profit, and providing additional charging services with a given number of charging terminals.

Embodiments of the present disclosure are as set forth in the following parentheticals.

(1) A method of optimizing operation of a charging station, comprising: receiving, from each user of a plurality of users of the charging station, user inputs including a planned departure time and a desired energy requirement, wherein said each user is docked at a respective charging terminal of the charging station; generating a set of pricing options including a price for charging and a price for overstaying the planned departure time, wherein the set of pricing options includes a charging-ASAP pricing option and a charging-FLEX pricing option; transmitting the set of pricing options to said each user; receiving, from said each user, a selection of a pricing option from among the set of pricing options; generating a charging schedule; transmitting the generated charging schedule and a set of power transfer specifications to the respective charging terminal; and charging a battery of a vehicle docked at the respective charging terminal according to the generated charging schedule and the set of power transfer specifications.

(2) The method of (1), further comprising: providing said each user with a website address for registering a user device with a charging provider; registering the user device at the website address of the charging provider; and requesting the planned departure time and/or the desired energy requirement from the user through the website address.

(3) The method of any one of (1) to (2), further comprising: providing the user with a downloadable computing application for registering the user device with a charging provider; registering the user device with the downloadable computing application of the charging provider; and requesting the planned departure time and/or the desired energy requirement from the user through the downloadable computing application.

(4) The method of any one of (1) to (3), further comprising: maximizing an expected gross profit and minimizing an operational cost of the charging station by maximizing an optimization formulation, wherein the optimization formulation is given by:

[symbol]

[f(z,y,u,M)]+Jₜₑᵣₘᵢₙₐₗ(ω_{T})

=Pᵣ(M=flex)f^{flex}(z_{flex},y_{flex},u_{flex},v)

+Pᵣ(M=asap)f^{asap}(zₐₛₐₚ,yₐₛₐₚ,uₐₛₐₚ,v)

+Pᵣ(M=leave)f^{leave}(z_{flex},zₐₛₐₚ,y_{flex},yₐₛₐₚ,u_{flex},uₐₛₐₚ,v)

+Jₜₑᵣₘᵢₙₐₗ(ω_{T}),

where [symbol] [f(z, y, u, M)] is the expected gross profit, Jₜₑᵣₘᵢₙₐₗ(wᵣ) is the operational cost of the charging station, M is the set of pricing options, z is a per-unit price of charging for each pricing option of the set of pricing options, y is a per-unit overstay penalty for each pricing option of the set of pricing options, u is a charging power for a given pricing option selected by an incoming user, Pᵣ(M=flex) is a probability that the incoming user will select the charging-FLEX pricing option, f^{flex}(z_{flex}, y_{flex}, u_{flex}, v) is a function of a charging-FLEX profit of the charging-FLEX pricing option, z_{flex} is a per-unit price of the charging-FLEX pricing option, y_{flex} is a per-unit overstay price associated with the charging-FLEX pricing option, u_{flex} is a charging power for the incoming user for the charging-FLEX pricing option, V is a charging power for said each user, Pᵣ(M=asap) is a probability the incoming user will select the charging-ASAP pricing option, f^{asap}(zₐₛₐₚ, yₐₛₐₚ, uₐₛₐₚ, v) is function of an ASAP profit of the charging-ASAP pricing option, where zₐₛₐₚ is a per-unit price of the charging-ASAP pricing option, yₐₛₐₚ is a per-unit overstay price associated with the charging-ASAP pricing option, uₐₛₐₚ is a charging power for the incoming user for the charging-ASAP pricing option, Pᵣ(M=leave) is a probability the incoming user will leave without charging and f^{leave} is a function of an opportunity cost of the incoming user selecting to leave without charging.

(5) The method of any one of (1) to (4), wherein the function of the charging-FLEX profit for the charging-FLEX pricing option is given by:

$${f}^{flex} = {\sum }_{t = τ}^{{T}_{flex} - 1} ( {z}_{flex} - {c}_{t} ) Δ t \cdot {u}_{flex , t} + Λ ( {y}_{flex} ) + {\sum }_{i ∈ {𝒜}_{flex}}^{ } [ {\sum }_{t = τ}^{{T}_{i}} ( {ζ}_{i} - {c}_{t} ) Δ t \cdot {υ}_{i , t}^{flex} + Λ ( {ξ}_{i} ) ] + {\sum }_{j ∈ {𝒜}_{asap}}^{ } [ {\sum }_{t = τ}^{{T}_{j}} ( {ζ}_{j} - {c}_{t} ) Δ t \cdot {υ}_{j , t} + Λ ( {ξ}_{j} ) ] - {e}_{D} ⌈ {D}_{{T}_{end}^{flex}} - {D}_{0} ⌉$$

where cₜ is a utility rate, T_{flex} is a parking duration based on the planned departure time, τ is a starting time, Eⱼ and Eᵢ are undefined errors, ζᵢ is a charging-FLEX price for said each user, ζⱼ is a charging-FLEX price for the incoming user j, Λ(ξᵢ) is a fixed overstay price for said each user i, v_{j,t} is a charging power for the incoming user j, Λ(ιⱼ) is a fixed overstay price for the incoming user j, v_{i,t}^{flex} is a charging power for charging-FLEX for said each user i at time t, c_{D} is a utility rate for a demand charge, D_{Tflex_end} is the demand charge at an end of charging, and D₀ is the demand charge at a start of charging.

(6) The method of any one of (1) to (5) wherein the function of the charging-ASAP profit for the charging-ASAP pricing option is based on:

$$\text{?} = \text{?} ( \underbrace{{z}_{asap}}_{revenue} - \underbrace{{c}_{t}}_{utility rate} ) Δ t \cdot {u}_{asap , t} + Λ ( {y}_{asap} ) + {\sum }_{i ∈ {𝒜}_{flex}}^{ } [ {\sum }_{t = τ}^{{T}_{t}} ( {ζ }_{t} - {c}_{t} ) Δ t \cdot {υ}_{i , t}^{asap} + Λ ( {ξ}_{i} ) ] + {\sum }_{j ∈ {𝒜}_{asap}}^{ } [ {\sum }_{t = τ}^{{T}_{j}} ( {ζ }_{j} - {c}_{t} ) Δ t \cdot {υ}_{j , t} + Λ ( {ξ}_{j} ) ] - {c}_{D} [ \text{?} - {D}_{0} ]$$

$$\text{?} \text{indicates text missing or illegible when filed}$$

where cₜ is a utility rate, Tₐₛₐₚ is a parking duration based on the planned departure time, τ is a starting time, εⱼ and εᵢ are undefined errors, ζᵢ is a charging-ASAP price for said each user, v_{i,t}^{asap} is a charging power for charging-ASAP for said each user i at time is a charging-ASAP price for the incoming user, Λ(ξᵢ) is a fixed overstay price for said each user i, v_{j,t} is a charging power for the incoming user j, Λ(ξⱼ) is a fixed overstay price for the incoming user j, c_{D} is a utility rate for a demand charge, D_{Tasap_end} is the demand charge at an end of charging, and D₀ is the demand charge at a start of charging.

(7) The method of any one of (1) to (6), wherein the function of the opportunity cost of the incoming user leaving without charging is given by:

$${f}^{leave} = - {P}_{r} ( M = flex ) {f}^{flex} ( {z}_{flex} , {y}_{flex} , {u}_{flex} , v ) - Pr ( M = asap ) {f}^{asap} ( {z}_{asap} , {y}_{asap} , {u}_{asap} , v ) = {\sum }_{τ = t}^{{T}_{n}^{asap} - 1} ( {c}_{k} - 0 ) \cdot {p}^{max} \cdot Δ t$$

where cₖ is a utility rate for a kth selection of said each pricing option, p^{max} is a maximum power available at the respective charging terminal, and τ is a starting time.

(8) The method of any one of (1) to (7), further comprising: applying constraints to the optimization formulation, wherein the constraints include flex constraints for the charging-FLEX pricing option, asap constraints for the charging-ASAP pricing option, leave constraints for the incoming user selecting to leave without charging, and demand charge constraints.

(9) The method of any one of (1) to (8), wherein the flex constraints for the charging-FLEX pricing option are:

e_{n,τ}_{₀}^{flex}=0,

e_{i,t+1}=e_{i,t}+Δt·η·p_{i,t}∀i∈ [symbol] _{flex},

Eᵢ^{req}≤e_{i,T}_{ᵢ},

0≤p_{i,t}≤p^{max},

where e_{n,τ}_{₀}^{flex} is an added energy level at a zero starting time, τ₀, e_{i,t} is an accumulative added energy level for said each user i at time t, η is an efficiency of the respective charging terminal, p_{i,t} is power transferred to said each user i at time t, [symbol] flex is a subset of the plurality of users who select the charging-FLEX pricing option, Eᵢ^{req} is the desired energy requirement of said each user i, Tᵢ is the planned departure time of said each user i, and p^{max} is a maximum amount of power which can be transferred to the battery of the vehicle docked at the respective charging terminal.

(10) The method of any one of (1) to (9), further comprising: applying constraints for in-progress charging-FLEX services, based on:

e_{i,t+1}^{flex}=e_{i,t}^{flex}+Δt·η·v_{i,t}^{flex}∀i∈ [symbol] _{flex}

e_{i,t=0}^{flex}=e_{i,τ}

e_{i,T}_{ᵢ}^{flex}≥E_{req,i}

0≤v_{i,t}^{flex}≤uₘₐₓ

where E_{req,i} is the amount of energy added for said each user i and uₘₐₓ is a charging power for the incoming user for the charging-FLEX pricing option.

(11) The method of any one of (1) to (10), wherein the asap constraints for the charging-ASAP pricing option are:

e_{j,t+1}=e_{j,t}+Δt·η·p_{j,t}∀j∈ [symbol] ₐₛₐₚ,

e_{i,t=0}=e_{j,τ}

v_{j,t}=uₘₐₓ, for t=0,1, . . . ,Tⱼ,

where p_{j, t}=pₘₐₓ

$$\text{?} = \frac{\text{?}}{\text{?}} , \\ \text{?} \text{indicates text missing or illegible when filed}$$

e_{i,t} is an accumulative added energy level for said each user i at time t, [symbol] asap is a subset of the plurality of users who select the charging-ASAP pricing option, p represents power, Eᵢ^{req} is the desired energy requirement for the charging-ASAP pricing option, and uₘₐₓ is a charging power for the incoming user.

(12) The method of any one of (1) to (10), wherein the demand charge constraints for the charging-FLEX pricing option are given by:

$${G}_{t}^{flex} = {u}_{flex , t} + {\sum }_{i ∈ {𝒜}_{flex}}^{ } {υ}_{i , t}^{flex} + {\sum }_{j ∈ {𝒜}_{asap}}^{ } {υ}_{j , t}$$

$${G}_{t}^{flex} \leq {G}_{max}$$

$${D}_{t}^{flex} = max \{ {G}_{t}^{flex} , {D}_{t}^{flex} \}$$

$${D}_{t = 0}^{flex} = {D}_{τ}$$

$${T}_{end}^{flex} = max \{ {T}_{i} \vert i ∈ {𝒜}_{flex} ⋃ {𝒜}_{asap} ⋃ flex \}$$

where Gₜ^{flex} represents a power consumption of the charging station at time t, [symbol] _{flex} is a subset of the plurality of users who select the charging-FLEX pricing option, [symbol] ₐₛₐₚ is a subset of the plurality of users who select the charging-ASAP pricing option, Gₘₐₓ is a total power needed to meet the desired energy requirement, Dₜ₊₁^{flex} is the demand charge at time t+1 for the charging-FLEX pricing option, Dₜ₌₀^{flex} is the demand charge at time t=0 for the charging-FLEX pricing option, T_{end}^{flex} is the planned departure time for said each user i at the end of a charging session.

(12) The method of any one of (1) to (11), further comprising applying constraints for in-progress charging-FLEX services, based on:

e_{i,t+1}^{flex}=e_{i,t}^{flex}+Δt·η·v_{i,t}^{flex}∀i∈ [symbol] _{flex}

e_{i,t=0}^{flex}=e_{i,τ}

e_{i,T}_{ᵢ}^{flex}≥E_{req,i}

0≤v_{i,t}^{flex}≤uₘₐₓ

(13) The method of any one of (1) to (12), further comprising: determining a probability of said each user selecting a particular pricing option, m, by formulating a non-convex utility function based on a discrete choice model, wherein the non-convex utility function, Uₘ, is given by:

Uₘ=βₘ^{T}zₘ+γₘ^{T}wₘ+β₀ₘ+∈ₘ,

where zₘ is a set of incentive controls for a selection of a pricing option m, w is a set of exogenous variables, βₘ and γₘ are weights for controllable inputs and uncontrollable inputs, respectively, β₀ₘ is an alternative specific constant, T is a symbol indicating a transpose, and çₘ is a latent variable that accounts for unspecified errors due to white noise at an energy providing utility.

(14) The method of any one of (1) to (13), further comprising: determining a probability of said each user selecting a j^{th} pricing option, based on:

$$Pr ( alternative j is chosen ) = \frac{{e}^{{V}_{j}}}{{\sum }_{u = 1}^{M} {e}^{{V}_{n}}} ,$$

where

$${v}_{j} \mathring{=} {β}_{j}^{⊤} {z}_{j} + {γ}_{j}^{⊤} {w}_{j} + {β}_{0}$$

is the non-convex utility function without errors.

(15) The method of any one of (1) to (14), further comprising: reformulating the non-convex utility function into a multi-block convex problem.

(16) The method of any one of (1) to (15), further comprising: applying a block coordinate descent algorithm to the multi-block convex problem to determine the pricing options.

(17) A system for optimizing the operation and costs of a fleet of charging stations, comprising: a fleet of charging stations, each charging station including a plurality of charging terminals; a user interface configured to receive user inputs and to display a set of pricing options, wherein the user interface is associated with a website address or a downloadable native application; and cloud computing infrastructure configured to: receive the user inputs from the user interface, the user inputs including a planned departure time and a desired energy requirement for a respective charging terminal of said each charging station, generate the set of pricing options including a price for charging and a price for overstaying the planned departure time, wherein the set of pricing options includes a charging-ASAP pricing option and a charging-FLEX pricing option, transmit the set of pricing options to the user interface, receive a selection of a particular pricing option from the user interface, generate a charging schedule, and transmit the generated charging schedule and a set of power transfer specifications to the respective charging terminal, wherein the respective charging terminal is configured to charge a battery of a vehicle docked at the respective charging terminal according to the generated charging schedule and the set of power transfer specifications.

(18) The system of (17), wherein the cloud computing infrastructure is further configured to: generate the set of pricing options to maximize an expected gross profit of said each charging station and minimize an operational cost of said each charging station by maximizing an optimization formulation, wherein the optimization formulation is given by:

[symbol]

[f(z,y,u,M)]Jₜₑᵣₘᵢₙₐₗ(ω_{T})

=Pᵣ(M=flex)f^{flex}(z_{flex},y_{flex},u_{flex},v)

+Pᵣ(M=asap)f^{asap}(zₐₛₐₚ,yₐₛₐₚ,uₐₛₐₚ,v)

+Pᵣ(M=leave)f^{leave}(z_{flex},zₐₛₐₚ,y_{flex},yₐₛₐₚ,u_{flex},uₐₛₐₚ,v)

+Jₜₑᵣₘᵢₙₐₗ(ω_{T}),

where [symbol] [f(z, y, u, M)] is an expected gross profit, Jₜₑᵣₘᵢₙₐₗ(w_{T}) is the operational cost of said each charging station, z is a per-unit price of charging for each pricing option of the set of pricing options, y is a per-unit penalty for each pricing option of the set of pricing options, u is a charging power for a given pricing option selected at the user interface by an incoming user, M is the set of pricing options, Pᵣ(M=flex) is a probability that the incoming user will select the charging-FLEX pricing option, f^{flex}(z_{flex}, y_{flex}, u_{flex}, v) is a function of a charging-FLEX profit of the charging-FLEX pricing option, z_{flex} is a per-unit price of the charging-FLEX pricing option, y_{flex} is a per-unit overstay price associated with the charging-FLEX pricing option, u_{flex} is a charging power for the incoming user for the charging-FLEX pricing option, v is a charging power for said each user, Pᵣ(M=asap) is a probability the incoming user will select the charging-ASAP pricing option, f^{asap}(zₐₛₐₚ, yₐₛₐₚ, uₐₛₐₚ, v) is function of an ASAP profit of the charging-ASAP pricing option, where zₐₛₐₚ is a per-unit price of the charging-ASAP pricing option, yₐₛₐₚ is a per-unit overstay price associated with the charging-ASAP pricing option, uₐₛₐₚ is a charging power for the incoming user for the charging-ASAP pricing option, Pᵣ(M=leave) is a probability the incoming user will leave without charging, and f^{leave} is a function of an opportunity cost of the incoming user leaving without charging.

(19) The system of any one of (17) to (18), wherein the cloud computing infrastructure is further configured to: determine a probability of the selection of a particular pricing option, m, by formulating a non-convex utility function based on a discrete choice model, wherein said non-convex utility function, U, is given by:

Uₘ=βₘ^{T}zₘ+γₘ^{T}wₘ+β₀ₘ+∈ₘ,

where zₘ is a set of incentive controls for a selection of a pricing option m, w is a set of exogenous variables, βₘ and γₘ are weights for controllable inputs and uncontrollable inputs, respectively, β₀ₘ is an alternative specific constant, T is a symbol indicating a transpose, and ∈ₘ is a latent variable that accounts for unspecified errors due to white noise at an energy providing utility; reformulate the non-convex utility function into a multi-block convex problem; and apply a block coordinate descent algorithm to the multi-block convex problem to determine the set of pricing options.

(20) A non-transitory computer readable medium having instructions stored therein that, when executed by one or more processors, cause the one or more processors to perform a method of optimizing charging station operation, comprising: receiving, from each user of a plurality of users of the charging station, user inputs including a planned departure time and a desired energy requirement, wherein said each user is docked at a respective charging terminal of the charging station; generating a set of pricing options including a price for charging and a price for overstaying the planned departure time, wherein the set of pricing options includes a charging-ASAP pricing option and a charging-FLEX pricing option; transmitting the set of pricing options to said each user; receiving, from said each user, a selection of a pricing option from among the set of pricing options; generating a charging schedule; transmitting the generated charging schedule and a set of power transfer specifications to the respective charging terminal; and charging a battery of a vehicle docked at the respective charging terminal according to the generated charging schedule and the set of power transfer specifications.

Numerous modifications and variations of the described embodiments are possible in light of the above description. It is therefore to be understood that within the scope of the appended claims, the invention may be practiced otherwise than as specifically described herein.

Appendix A. Reformulation Process and Proof

Appendix A.1. Compact Form Representation

The objective function of equations (16)-(20) is rewritten in the compact form

$$\begin{matrix}{min}_{z ∈ Z} {σ ( Θ z )}_{flex} \cdot ( {min}_{x ∈ χ} {h}_{flex} ( z , x ) ) + {σ ( Θ z )}_{asap} \cdot ( {min}_{x ∈ χ} {h}_{asap} ( z , x ) ) + & ( A .1 ) \\ {σ ( Θ z )}_{ℓ} \cdot {h}_{ℓ} ( z ) = & ( A .2 ) \\ {min}_{z ∈ Z , x ∈ χ} {σ ( Θ z )}^{⊤} h ( z , x ) , & ( A .3 ) \\ where & \\ {σ ( Θ z )}_{j} = \frac{exp {θ}_{j}^{⊤} z}{{\sum }_{i ∈ ℳ}^{ } exp {θ}_{i}^{⊤} z} , ∀ j ∈ 𝒜 , & ( A .4 ) \\ h ( z , x ) = [ \begin{matrix}{h}_{flex} ( z , x ) \\ {h}_{asap} ( z , x ) \\ {h}_{ℓ} ( z )\end{matrix} ] = [ \begin{matrix}{f}_{flex} ( z ; x ) + \text{?} ( z ) \\ {f}_{asap} ( z ; x ) + \text{?} ( z ) \\ {f}_{ℓ} ( z )\end{matrix} ] , & ( A .5 ) \\ z = {[ \begin{matrix}{z}_{flex} & {z}_{asap} & y & 1\end{matrix} ]}^{⊤} , & ( A .6 ) \\ Θ = {[ \begin{matrix}{θ}_{flex} & {θ}_{asap} & {θ}_{ℓ}\end{matrix} ]}^{⊤} , & ( A .7 ) \\ 𝒵 is the domain of z , & ( A .8 ) \\ χ is the domain of x , satisfying ( 1 ) \text{-} ( 4 ) . & ( A .9 ) \\ \text{?} \text{indicates text missing or illegible when filed} & \end{matrix}$$

Appendix A.2. Reformulation to Multi-block Convex Problem

Note that the softmax function is a non-linear and non-convex function, and hence the problem (A.3) is non-convex. The problem is reformulated into a multi-block convex problem by investigating the problem structure and applying the Fenchel-Young inequality theorem. First, by introducing variable v, the problem (A.3) is written as

$$\begin{matrix}{min}_{z ∈ Z , x ∈ χ} {υ}^{⊤} h ( z , x ) , & ( A .10 a ) \\ where υ = σ ( Θz ) . & ( A .10 b )\end{matrix}$$

It can be noted that the objective function in Eqn. (A.10a) is a three-block multi-convex with respect to z, x, and v. However, the non-convex equality (A.10b) is added and it is reformulated as a bi-convex constraint in the following section.

Appendix A.2.1. Bi-convex Representation of Eqn. (A.10b)

Consider the Log-Sum-Exponential function:

$$LSE ( u ) = ln ( {\sum }_{j ∈ 𝒜}^{ } exp ( {u}_{j} ) ) . \qquad ( A .11 )$$

Given u∈ [symbol] ⁿ,

LSE(u)=In(1^{T}ₑₓₚ(u)), (A.12)

∇LSE(u)=σ(u), (A.13)

where exp(u)×[exp(u₁) . . . exp(uₙ)].

The convex conjugate (a.k.a. Legendre-Fenchel transformation) of Log-Sum-Exponential is defined as

$$LSE * ( υ ) {=}^{△} {max}_{u} {u}^{⊤} υ - LSE ( u ) . \qquad ( A .14 )$$

The convex conjugate of LSE reads:

$$LSE * ( υ ) = \{ \begin{matrix}{υ}^{⊤} ln ( υ ) & if υ \geq 0 and {1}^{⊤} υ = 1 , \\ ∞ & otherwise\end{matrix} \qquad ( A .15 )$$

### Let

$$V {=}^{△} \{ v \vert \vert v \geq 0 , {1}^{T} v = 1 \}$$

denote a set of finite discrete probability distributions. The Fenchel-Young inequality then reads:

LSE*(v)−u^{T}v+LSE(u)≥0,∀u,∀v∈ [symbol] . (A.16)

The equality in Eqn. (A.16) is true if and only if

u_{*}=argmaxᵤu^{T}v−LSE(u). (A.17)

where u* is a maximizer since Log-Sum-Exponential is convex and differentiable for all u.

The first-order optimality condition for Eqn. (A.17) derives

v=∇LSE(u_{*)}=σ(u_{*}). (A.18)

Hence, the following suffices:

LSE*(v)−u_{*}^{T}v+LSE(u_{*)≤}0⇔v=σ(u_{*}). (A.19)

The inequality constraint in Eqn. (A.19) can be replaced with the equality in Eqn. (A.10b). Next, replace u_{*} with Θz in Eqn. (A.19), i.e.,

LSE*(v)−v^{T}(Θz)+LSE(Θx)≤0. (A.20)

The above inequality is relaxed by introducing a precision parameter E as LSE*(v)−v^{T}(Θz)+LSE(Θz)≤ε. This inequality represents a bi-convex set w.r.t. (z, v).

Appendix A.2.2. Reformulation of Eqn. (A.10) into Multi-block Convex Problem

Eventually, the original problem (A.10) is reformulated and relaxed as

$${min}_{z ∈ Z , x ∈ χ} {υ}^{⊤} h ( z , x ) \\ subject to \text{:} LSE * ( υ ) - {υ}^{⊤} ( Θ z ) + LSC ( Θ z ) \leq ɛ , \qquad ( A .21 )$$

which is three-block convex w.r.t. (z, x, v).

Appendix A.3. Block Coordinate Descent (BCD) Algorithm

The Block Coordinate Descent algorithm effectively solves a multi-convex problem.

It is applied to the problem in Eqn. (A.21). An update of each variable (z, x, v) solves the convex problem. Details of the algorithm are presented in Algorithm 1.

Algotithm 1: Block Coordinate Descent Algorithm

| Init: | x⁽⁰⁾ = x₆, x⁽⁰⁾ = x₀, ν⁽⁰⁾ = σ(Θz₀) | |
|---|---|---|
| | | F⁽⁰⁾ = ν^{(0)T}h(z⁽⁰⁾, x⁽⁰⁾) |

1 while ∥F⁽ⁱ⁺¹⁾ − F⁽⁰⁾∥ > ϵdo

| | | |
|---|---|---|
| 2 | \| | x⁽ⁱ⁺¹⁾ = argmin_{xϵx} ϵ^{(1)T}h(z^{(b)}, x) |
| 3 | \| | x⁽ⁱ⁺¹⁾ = argmin_{xϵZ} ν^{(0)T}h(z,x⁽⁰⁺¹⁾ + μ(LSE(σz)^{T}∂⁽⁰⁾) |
| 4 | \| | υ⁽⁰⁺¹⁾ = argmin_{zϵυ}∂^{T}h(zⁱ⁺¹⁾) + μ(LSE*(υ) − |
| | | (Θxi+1))Tυ) |

| | |
|---|---|
| 5 | end |

It can be noted that each update of the variables solves a strongly convex problem where the objective function (A.10a) is differentiable with a Lipschitz continuous gradient. Hence, the BCD algorithm has a linear convergence rate. As a result, there is high practical value since it enables real-time implementation.

Expected Cost Minimization w/ Discrete Choice Model

Expected Cost Minimization Problem

$${min}_{z , u} {\sum }_{j}^{ } Pr ( J = j \vert z ) {h}_{j} ( z , u )$$

where z is incentive control, u is direct control, and hⱼ (z, u) is bi-convex in (z, u).
The compact form is:

$${min}_{z , u} {v}^{T} h ( z , u )$$

where v=sm(Θz)

Re-formulate into a multi-convex problem:

min_{z,u}v^{T}h(z,u) becomes min_{z,u,v}v^{T}h(z,u), subject to: lse(Θz)+lse*(v)−v^{T}(Θz)≤0, v=sm(Θz), where lse(x)=log(Σⱼ exp(xⱼ)) is multi-convex in (z,u,v) and apply the block coordinate descent algorithm.

The discrete choice model incorporates randomly generated arrivals, probability of choice, depending on desired departure time, desired energy, and time-of-day

Monte Carlo Simulations enable comparison of the pricing and scheduling controller with a charging station operation without the control framework. Results demonstrate:
41% reduction in mean overstay time
38% increase in mean net profit
32% increase in mean number of PEVs served
The pricing choices encourage FLEX charging during peak hours
Peak tariff is 12 noon to 5 PM
Significant discount for FLEX vs. ASAP during/just-prior to peak

Aspects of the present disclosure describe:
PEV Smart Charging Pilot for incentivizing service choice
Cyber-Physical & Human system modeling framework, with discrete choice models
Theoretical reformulation of optimal pricing and scheduling to convert into a multi-convex optimization program.

1. A method of optimizing operation of a charging station, comprising:
receiving, from each user of a plurality of users of the charging station, user inputs including a planned departure time and a desired energy requirement, wherein said each user is docked at a respective charging terminal of the charging station;
generating a set of pricing options including a price for charging and a price for overstaying the planned departure time, wherein the set of pricing options includes a charging-ASAP pricing option and a charging-FLEX pricing option;
transmitting the set of pricing options to said each user;
receiving, from said each user, a selection of a pricing option from among the set of pricing options;
generating a charging schedule;
transmitting the generated charging schedule and a set of power transfer specifications to the respective charging terminal; and
charging a battery of a vehicle docked at the respective charging terminal according to the generated charging schedule and the set of power transfer specifications.

2. The method of claim 1, further comprising:
providing said each user with a website address for registering a user device with a charging provider;
registering the user device at the website address of the charging provider; and
requesting the planned departure time and/or the desired energy requirement from the user through the web site address.

3. The method of claim 1, further comprising:
providing said each user with a downloadable native application for registering a user device with a charging provider;
registering the user device with the downloadable native application of the charging provider; and
requesting the planned departure time and/or the desired energy requirement from said each user through the downloadable native application.

4. The method of claim 1, further comprising:
maximizing an expected gross profit and minimizing an operational cost of the charging station by maximizing an optimization formulation, wherein the optimization formulation is given by: [symbol]
[f(z,y,u,M)]Jₜₑᵣₘᵢₙₐₗ(ω_{T}),
=Pᵣ(M=flex)f^{flex}(z_{flex},y_{flex},u_{flex},v)
+Pᵣ(M=asap)f^{asap}(zₐₛₐₚ,Yₐₛₐₚ,uₐₛₐₚ,v)
+Pᵣ(M=leave)f^{leave}(z_{flex} zₐₛₐₚ,y_{flex},yₐₛₐₚ,u_{flex},uₐₛₐₚ,v)
+Jₜₑᵣₘᵢₙₐₗ(ω_{T}),
where [symbol] [f(z, y, u, M)] is the expected gross profit, Jₜₑᵣₘᵢₙₐₗ(ω_{T}) is the operational cost of the charging station, M is the set of pricing options, z is a per-unit price of charging for each pricing option of the set of pricing options, y is a per-unit overstay penalty for each pricing option of the set of pricing options, u is a charging power for a given pricing option selected by an incoming user, Pᵣ(M=flex) is a probability that the incoming user will select the charging-FLEX pricing option, f^{flex}(z_{flex}, y_{flex}, u_{flex}, v) is a function of a charging-FLEX profit of the charging-FLEX pricing option, z_{flex} is a per-unit price of the charging-FLEX pricing option, y_{flex} is a per-unit overstay price associated with the charging-FLEX pricing option, u_{flex} is a charging power for the incoming user for the charging-FLEX pricing option, v is a charging power for said each user, Pᵣ(M=asap) is a probability the incoming user will select the charging-ASAP pricing option, f^{asap}(zₐₛₐₚ, yₐₛₐₚ, uₐₛₐₚ, v) is function of an ASAP profit of the charging-ASAP pricing option, where zₐₛₐₚ is a per-unit price of the charging-ASAP pricing option, yₐₛₐₚ is a per-unit overstay price associated with the charging-ASAP pricing option, uₐₛₐₚ is a charging power for the incoming user for the charging-ASAP pricing option, Pᵣ(M=leave) is a probability the incoming user will leave without charging and f^{leave} is a function of an opportunity cost of the incoming user selecting to leave without charging.

5. The method of claim 4, wherein the function of the charging-FLEX profit for the charging-FLEX pricing option is given by:
$${f}^{flex} = {\sum }_{t = r}^{{T}_{flex} - 1} ( {z}_{flex} - {c}_{i} ) Δ t \cdot {u}_{flex , t} + Λ ( {y}_{flex} ) + {\sum }_{i ∈ {A}_{flex}}^{ } [ {\sum }_{t = τ}^{{T}_{t}} ( {ζ}_{i} - {c}_{t} ) Δ t \cdot {v}_{i , t}^{flex} + Λ ( {ξ}_{i} ) ] + {\sum }_{j ∈ {A}_{asap}}^{ } [ {\sum }_{t = τ}^{{T}_{j}} ( {ζ}_{j} - {c}_{t} ) Δ t \cdot {v}_{j , t} + Λ ( {ξ}_{j} ) ] - {c}_{D} ⌈ {D}_{{T}_{end}^{flex}} - {D}_{0} ⌉$$
where cₜ is a utility rate, T_{flex} is a parking duration based on the planned departure time, τ is a starting time, Λ(y_{flex}) is a fixed overstay price for the charging station, εⱼ and εₜ are undefined errors, ζᵢ is a charging-FLEX price for said each user, ζⱼ is a charging-FLEX price for the incoming user j, Λ(ξᵢ) is a fixed overstay price for said each user i, Λ(ξⱼ) is a fixed overstay price for the incoming user j, v_{i,t}^{flex} is a charging power for charging-FLEX for said each user i at time t, v_{j,t} is a charging power for the incoming user j, c_{D} is a utility rate for a demand charge, D_{Tflex_end} is the demand charge at an end of charging, and D₀ is the demand charge at a start of charging.

6. The method of claim 4, wherein the function of the charging-ASAP profit for the charging-ASAP pricing option is based on:
$${f}_{asap} = {\sum }_{t = τ}^{{T}_{asap} - 1} ( \underbrace{{z}_{asap}}_{revenue} - \underbrace{{c}_{t}}_{utility rate} ) Δ t \cdot {u}_{asap , t} + Λ ( {y}_{asap} ) + {\sum }_{i ∈ {A}_{flex}}^{ } [ {\sum }_{t = τ}^{{T}_{i}} ( {ζ}_{i} - {c}_{t} ) Δ t \cdot {υ}_{i , t}^{flex} + Λ ( {ξ}_{i} ) ] + {\sum }_{j ∈ {A}_{asap}}^{ } [ {\sum }_{t = τ}^{{T}_{j}} ( {ζ}_{j} - {c}_{t} ) Δ t \cdot {v}_{j , t} + Λ ( {ξ}_{j} ) ] - {c}_{D} ⌈ {D}_{{T}_{end}^{flex}} - {D}_{0} ⌉$$
where et is a utility rate, Tₐₛₐₚ is a parking duration based on the planned departure time, t is a starting time, εⱼ and εᵢ are undefined errors, ζᵢ is a charging-ASAP price for said each user, ζⱼ is a charging-ASAP price for the incoming user, v_{i,t}^{asap} is a charging power for charging-ASAP for said each user i at time t, Λ(ξᵢ) is a fixed overstay price for said each user i, v_{j,t} is a charging power for the incoming user j, Λ(ξⱼ) is a fixed overstay price for the incoming user j c_{D} is a utility rate for a demand charge, D_{Tasap_end} is the demand charge at an end of charging, and D₀ is the demand charge at a start of charging.

7. The method of claim 4, wherein the function of the opportunity cost of the incoming user leaving without charging is given by:
$${f}^{leave} = - {P}_{r} ( M = flex ) {f}^{flex} ( {z}_{flex} , {y}_{flex} , {u}_{flex} , v ) - Pr ( M = asap ) {f}^{asap} ( {z}_{asap} , {y}_{asap} , {u}_{asap} , v ) = {\sum }_{τ = t}^{{T}_{n}^{asap} - 1} ( {c}_{k} - 0 ) \cdot {p}^{max} \cdot Δ t$$
where cₖ is a utility rate for a kth selection of said each pricing option, p^{max} is a maximum power available at the respective charging terminal, and t is a starting time.

8. The method of claim 5, further comprising:
applying constraints to the optimization formulation, wherein the constraints include flex constraints for the charging-FLEX pricing option, asap constraints for the charging-ASAP pricing option, leave constraints for the incoming user selecting to leave without charging, and demand charge constraints.

9. The method of claim 8, wherein the flex constraints for the charging-FLEX pricing option are:
e_{η,τ}_{₀}^{flex}=0,
e_{i,t+1}=e_{i,t}+Δt·η·p_{i,t}∀i∈ [symbol] _{flex};
Eᵢ^{min}≤e_{i,T}_{ᵢ},
0≤p_{i,t}≤p^{max},
where e_{η,τ}_{₀}^{flex} is an added energy level at a zero starting time, τ₀, e_{i,t} is an accumulative added energy level for said each user i at time t, η is an efficiency of the respective charging terminal, p_{i,t} is power transferred to said each user i at time t, [symbol] _{flex} is a subset of the plurality of users who select the charging-FLEX pricing option, Eᵢ^{req} is the desired energy requirement of said each user i, Tᵢ is the planned departure time of said each user i, and p^{max} is a maximum amount of power which can be transferred to the battery of the vehicle docked at the respective charging terminal.

10. The method of claim 9, further comprising:
applying constraints for in-progress charging-FLEX services, based on:
e_{i,t+1}^{flex}=e_{i,t}^{flex}+Δt·η·v_{i,t}^{flex}∀i∈ [symbol] _{flex}
e_{i,t=0}^{flex}=e_{i,τ}
e_{i,T}_{ᵢ}^{flex}≥E_{req,i}
0≤v_{i,t}^{flex}≤uₘₐₓ
where E_{req,i} is the amount of energy added for said each user i and uₘₐₓ is a charging power for the incoming user for the charging-FLEX pricing option.

11. The method of claim 8, wherein the asap constraints for the charging-ASAP pricing option are:
e_{j,t+1}=e_{j,t}+Δt·η·p_{j,t}∀j∈ [symbol] ₐₛₐₚ,
e_{j,t=0}=e_{j,τ}
v_{j,t}=uₘₐₓ, for t=0,1, . . . ,Tⱼ,
where
$$\text{?} = \frac{\text{?}}{Δ t \cdot η \cdot \text{?}} , \\ \text{?} \text{indicates text missing or illegible when filed}$$
p_{j,t}=pₘₐₓ, e_{i,t} is an accumulative added energy level for said each user i at time t, [symbol] ₐₛₐₚ is a subset of the plurality of users who select the charging-ASAP pricing option, p represents power, Eᵢ^{req} is the desired energy requirement for the charging-ASAP pricing option, and uₘₐₓ is a charging power for the incoming user.

12. The method of claim 8, wherein the demand charge constraints for the charging-FLEX pricing option are given by:
$${G}_{t}^{flex} = {u}_{flex , t} + {\sum }_{i ∈ {𝒜}_{flex}}^{ } {υ}_{i , t}^{flex} + {\sum }_{j ∈ {𝒜}_{asap}}^{ } {υ}_{j , t}$$
$${G}_{t}^{flex} \leq {G}_{max}$$
$${D}_{t + 1}^{flex} = max \{ {G}_{t}^{flex} , {D}_{t}^{flex} \}$$
$${D}_{t = 0}^{flex} = {D}_{T}$$
$${T}_{end}^{flex} = max \{ {T}_{i} \vert i ∈ {𝒜}_{flex} ⋃ {𝒜}_{asap} ⋃ flex \} ,$$
where Gₜ^{flex} represents a power consumption of the charging station at time t, [symbol] _{flex} is a subset of the plurality of users who select the charging-FLEX pricing option, [symbol] ₐₛₐₚ is a subset of the plurality of users who select the charging-ASAP pricing option, Gₘₐₓ is a total power needed to meet the desired energy requirement, Dₜ₊₁^{flex} is the demand charge at time t+1 for the charging-FLEX pricing option, Dₜ₌₀^{flex} is the demand charge at time t=0 for the charging-FLEX pricing option, T_{end}^{flex} is the planned departure time for said each user i at the end of a charging session.

13. The method of claim 1, further comprising:
determining a probability of said each user selecting a particular pricing option, m, by formulating a non-convex utility function based on a discrete choice model, wherein the non-convex utility function, Uₘ, is given by:
Uₘ=βₘ^{T}zₘ+γₘ^{T}wₘ+β₀ₘ+ϵₘ
where zₘ is a set of incentive controls for a selection of a pricing option m, w is a set of exogenous variables, βₘ and γₘ are weights for controllable inputs and uncontrollable inputs, respectively, β₀ₘ is an alternative specific constant, T is a symbol indicating a transpose, and ϵₘ is a latent variable that accounts for unspecified errors due to white noise at an energy providing utility.

14. The method of claim 13, further comprising:
determining a probability of said each user selecting a j^{th} pricing option, based on:
$$Pr ( alternative j is chosen ) = \frac{{e}^{{v}_{j}}}{{\sum }_{n = 1}^{M} {e}^{{v}_{n}}} ,$$
where
$${v}_{j} \mathring{=} {β}_{j}^{⊤} {z}_{j} + {γ}_{j}^{⊤} {w}_{j} + {β}_{0}$$
is the non-convex utility function without errors.

15. The method of claim 14, further comprising:
reformulating the non-convex utility function into a multi-block convex problem.

16. The method of claim 15, further comprising:
applying a block coordinate descent algorithm to the multi-block convex problem to determine the pricing options.

17. A system for optimizing the operation and costs of a fleet of charging stations, comprising:
a fleet of charging stations, each charging station of the fleet including a plurality of charging terminals;
a user interface configured to receive user inputs and to display a set of pricing options, wherein the user interface is associated with a website address or a downloadable native application; and
cloud computing infrastructure configured to:
receive the user inputs from the user interface, the user inputs including a planned departure time and a desired energy requirement for a respective charging terminal of said each charging station,
generate the set of pricing options including a price for charging and a price for overstaying the planned departure time, wherein the set of pricing options includes a charging-ASAP pricing option and a charging-FLEX pricing option,
transmit the set of pricing options to the user interface,
receive a selection of a particular pricing option from the user interface,
generate a charging schedule, and
transmit the generated charging schedule and a set of power transfer specifications to the respective charging terminal,
wherein the respective charging terminal is configured to charge a battery of a vehicle docked at the respective charging terminal according to the generated charging schedule and the set of power transfer specifications.

18. The system of claim 17, wherein the cloud computing infrastructure is further configured to:
generate the set of pricing options to maximize an expected gross profit of said each charging station and minimize an operational cost of said each charging station by maximizing an optimization formulation, wherein the optimization formulation is given by: [symbol]
[f(z y,u,M)]+Jₜₑᵣₘᵢₙₐₗ(ω_{T})
=Pᵣ(M=flex)f^{flex}(z_{flex},y_{flex},u_{flex},v)
+Pᵣ(M=asap)fₐₛₐₚ(zₐₛₐₚ,yₐₛₐₚ,uₐₛₐₚ,v)
+Pᵣ(M=leave)f^{leave}(z_{flex},zₐₛₐₚ,v_{flex},vₐₛₐₚ,u_{flex},uₐₛₐₚ,v)
+Jₜₑᵣₘᵢₙₐₗ(ω_{T}),
where [symbol] [f(z, y, u, M)] is the expected gross profit, Jₜₑᵣₘᵢₙₐₗ(ω_{T}) is the operational cost of said each charging station, z is a per-unit price of charging for each pricing option of the set of pricing options, y is a per-unit penalty for each pricing option of the set of pricing options, u is a charging power for a given pricing option selected at the user interface by an incoming user, M is the set of pricing options, Pᵣ (M=flex) is a probability that the incoming user will select the charging-FLEX pricing option, f^{flex}(z_{flex}, y_{flex}, u_{flex}, v) is a function of a charging-FLEX profit of the charging-FLEX pricing option, z_{flex} is a per-unit price of the charging-FLEX pricing option, y_{flex} is a per-unit overstay price associated with the charging-FLEX pricing option, u_{flex} is a charging power for the incoming user for the charging-FLEX pricing option, v is a charging power for said each user, Pᵣ (M=asap) is a probability the incoming user will select the charging-ASAP pricing option, f^{asap}(zₐₛₐₚ, yₐₛₐₚ, uₐₛₐₚ, v) is function of an ASAP profit of the charging-ASAP pricing option, where zₐₛₐₚ is a per-unit price of the charging-ASAP pricing option, yₐₛₐₚ is a per-unit overstay price associated with the charging-ASAP pricing option, uₐₛₐₚ is a charging power for the incoming user for the charging-ASAP pricing option, Pᵣ(M=leave) is a probability the incoming user will leave without charging, and f^{leave} is a function of an opportunity cost of the incoming user leaving without charging.

19. The system of claim 17, wherein the cloud computing infrastructure is further configured to:
determine a probability of the selection of a particular pricing option, m, by formulating a non-convex utility function based on a discrete choice model, wherein said non-convex utility function, Uₘ, is given by:
Uₘ=βₘ^{T}zₘ+γₘ^{T}wₘ+β₀ₘ+ϵₘ,
where zₘ is a set of incentive controls for a selection of a pricing option m, w is a set of exogenous variables, βₘ and γₘ are weights for controllable inputs and uncontrollable inputs, respectively, β₀ₘ is an alternative specific constant, T is a symbol indicating a transpose, and ϵₘ is a latent variable that accounts for unspecified errors due to white noise at an energy providing utility;
reformulate the non-convex utility function into a multi-block convex problem; and
apply a block coordinate descent algorithm to the multi-block convex problem to determine the set of pricing options.

20. A non-transitory computer readable medium having instructions stored therein that, when executed by one or more processors, cause the one or more processors to perform a method of optimizing operation of a charging station, comprising:
receiving, from each user of a plurality of users of the charging station, user inputs including a planned departure time and a desired energy requirement, wherein said each user is docked at a respective charging terminal of the charging station;
generating a set of pricing options including a price for charging and a price for overstaying the planned departure time, wherein the set of pricing options includes a charging-ASAP pricing option and a charging-FLEX pricing option;
transmitting the set of pricing options to said each user;
receiving, from said each user, a selection of a pricing option from among the set of pricing options;
generating a charging schedule;
transmitting the generated charging schedule and a set of power transfer specifications to the respective charging terminal; and
charging a battery of a vehicle docked at the respective charging terminal according to the generated charging schedule and the set of power transfer specifications.
